(19) United States
(12) Patent Application Publication
(10) Pub. No.: US 2026/0084477 A1
(43) Pub. Date: Mar. 26, 2026

(54) APPARATUS FOR MANIPULATING AND/OR MANEUVERING A TRAILER SUPPORT

(71) Applicant: IDEAL WAREHOUSE INNOVATIONS, INC., Woodbridge (CA)

(72) Inventor: Joseph J. DI BIASE, Woodbridge (CA)

(21) Appl. No.: 19/103,305

(22) PCT Filed: Aug. 15, 2023
(86) PCT No.: PCT/CA2023/051083

§ 371 Date: Feb. 12, 2025

Related U.S. Application Data
(60) Provisional application No. 63/371,471, filed on Aug. 15, 2022.

(51) Int. Cl. B60D 1/66

(52) U.S. Cl. CPC B60D 1/66

(57) ABSTRACT

An apparatus that is mounted to a vehicle for manipulating and/or maneuvering a trailer support. The apparatus comprises first and second support structures with first and second contact members. The first support structure is movable relative to the apparatus frame between at least a first position and a second position. The first contact member of the first support structure can be releasably received by the trailer support to releasably couple the trailer support to the apparatus. By releasably coupling the trailer support to the apparatus mounted on the vehicle, the trailer support can be manipulated and/or maneuvered such as moved along a ground surface, or lifted off the ground surface and oved around relative to the ground surface, and positioned beneath the nose of a trailer by the apparatus and the vehicle.

### FIELD OF THE DISCLOSURE

The present disclosure relates generally to systems for manipulating and/or maneuvering trailer supports relative to transport trailers. In particular, the present disclosure relates to a vehicle-mounted apparatus for manipulating and/or maneuvering a trailer support.

### BACKGROUND OF THE DISCLOSURE

When a freight semi-trailer is left to be supported at its front end using only its landing gear, the semi-trailer is freestanding, i.e., without a mechanical connection between the kingpin of the trailer and the tractor unit or an auxiliary vehicle such as a dolly, including a shunt truck, a yard truck or yard jockey etc. When loading and unloading cargo from a freestanding freight trailer, the movement of the forklift truck along the floor of the freight trailer causes the freight trailer to move as well. While some movement of the freight trailer is inevitable, considerable movement can result in the trailer becoming separated from the dock or possibly tipping over. More importantly, the landing gear of the freight trailer is not designed to accommodate the weight of a fully loaded trailer, let alone the dynamic forces generated by a forklift truck moving through a partially loaded freight trailer. Even further, the high center of gravity associated with most freight trailers makes the likelihood of tipping over a real possibility. The obvious implications of a freight trailer tipping over include damage to the goods within the trailer, the trailer itself, and the forklift truck, not to mention the possible serious injury to, or death of, an operator. In order to ensure that the trailer does not nosedive in case of landing gear failure, or that the trailer tips over on either lateral side, it is known in the art to provide a trailer support, also known as a trailer stand, a trailer support stand, a trailer jack, a trailer jack stand, a trailer stabilizing device etc., under the nose of the trailer to support and distribute the load of the trailer, especially in the case of failure or collapse of the trailer's landing gear, to prevent nose diving or lateral tip over of the trailer.

Some current trailer supports are manually placed under and retrieved from underneath the trailer by an operator. These such manually placed trailer supports may leave the operator in a vulnerable position underneath or near the trailer that could lead to injury or death of the operator if the trailer were to collapse at that time.

Within existing trailer supports, there are various “shuntable” devices that are designed to be maneuvered and positioned using, for example, an auxiliary vehicle, and do not require manual positioning by an operator. More specifically, these designs allow the trailer supports to be maneuvered and positioned entirely using the auxiliary vehicle. These trailer supports are reversed or backed into place by the auxiliary vehicle. A drawback of these “shuntable” trailer supports can be that they are mounted on wheels and are simply reversed or backed-up by the auxiliary vehicle. The wheels on these “shuntable” trailer supports, and the reversing or back-up maneuvering required to move these trailer supports can make these systems less than ideal, as the trailer support can be poorly maneuverable and difficult to use in busy, more congested loading facilities. The reversing or backing-up operation may have to be repeated several times in order to obtain the proper positioning of the trailer support underneath the nose of the trailer. The sometimes-poor maneuverability of these systems can mean that they can be inefficient at rapidly providing the necessary support to trailers that have been left at various locations around loading facilities. In addition, some of these “shuntable” trailer supports include mechanical, pneumatic or hydraulic jacks that are operable and position-able via the operator either directly or indirectly through the systems of the auxiliary vehicle. These types of devices may require the operator to hook up, make positioning adjustments, and disconnect the devices, while on or around the auxiliary vehicle. This leaves the operator in a vulnerable position to injury outside of the auxiliary vehicle and near the semi-trailer.

There is a need to provide a trailer support and a method of placing and retrieving the trailer support that overcomes the disadvantages of the prior art trailer supports.

### SUMMARY OF THE DISCLOSURE

According to an aspect, there is provided an apparatus for manipulating and/or maneuvering a trailer support, the apparatus for mounting to a vehicle for positioning the apparatus near the trailer support, the apparatus comprising: an apparatus frame for mounting to the vehicle; a first support structure comprising at least one first contact member, the first support structure being movably mounted to the apparatus frame for movement between at least a first position and a second position relative to the apparatus frame, the at least one first contact member being configured for being releasably received by the trailer support for releasably coupling the trailer support to the apparatus frame when the first support structure is moved from the first position to the second position; and an actuator connected to the apparatus frame and to the first support structure for driving an actuation of the first support structure from the first position to the second position for releasably coupling the trailer support to the apparatus frame.

In an embodiment, the at least one first contact member is shaped and/or sized for being releasably received by the trailer support for releasably coupling the trailer support to the apparatus frame when the first support structure is moved from the first position to the second position.

In an embodiment, when the trailer support is releasably coupled to the apparatus frame, the trailer support can be manipulated and/or maneuvered.

In an embodiment, when the trailer support is releasably coupled to the apparatus frame, the trailer support can be pushed or pulled by the vehicle via the apparatus frame mounted to the vehicle to maneuver the trailer support over a support surface.

In an embodiment, when the trailer support is releasably coupled to the apparatus frame, the trailer support can be lifted by the apparatus frame.

In an embodiment, the first support structure being movably mounted to the apparatus frame for movement between at least the first position, the second position, and a third position relative to the apparatus frame.

In an embodiment, the actuator is connected to the apparatus frame and to the first support structure for driving an actuation of the first support structure from the first position to the second position for releasably coupling the trailer support to the apparatus frame, and from the second position to the third position for lifting the releasably coupled trailer support relative to the apparatus frame.

In an embodiment, the at least one first contact member of the first support structure is a first contact beam.

In an embodiment, the first contact is a first circular contact beam.

In an embodiment, when the apparatus is mounted to the vehicle, the vehicle is positioned near to the trailer support and the actuator drives an actuation of the first support structure from the first position to the second position, the trailer support is releasably coupled to the apparatus frame.

In an embodiment, when the actuator drives an actuation of the first support structure from the second position to the third position, the releasably coupled trailer support is lifted relative to the apparatus frame.

In an embodiment, the apparatus further comprises a second support structure that is mounted to the apparatus frame and that comprises at least one second contact member that is configured for contacting the trailer support.

In an embodiment, the at least one second contact member is shaped and/or sized for contacting the trailer support.

In an embodiment, the at least one second contact member is configured to contact the trailer support while the trailer support is releasably coupled to the apparatus frame.

In an embodiment, the at least one second contact member is shaped and/or sized to contact the trailer support while the trailer support is releasably coupled to the apparatus frame.

In an embodiment, the at least one second contact member is configured to contact the trailer support while the apparatus lifts the releasably coupled trailer support relative to the apparatus frame.

In an embodiment, the at least one second contact member is shaped and/or sized to contact the trailer support while the apparatus lifts the releasably coupled trailer support relative to the apparatus frame.

In an embodiment, the second support structure is mounted to the apparatus frame such that the at least one second contact member is for contacting the trailer support at a location below where the at least one first contact member is releasably received by the trailer support.

In an embodiment, the at least one second contact member of the second support structure is a second contact beam.

In an embodiment, the second contact beam is a circular contact beam.

In an embodiment, the actuator comprises an actuator housing that is mounted to the apparatus frame, and a driving portion that is at least partially contained within the actuator housing.

In an embodiment, the driving portion of the actuator is connected to a battery that is housed within the actuator housing.

In an embodiment, the driving portion of the actuator is connected directly to a battery of the vehicle.

In an embodiment, the actuator is a winch.

In an embodiment, the winch comprises a load bearing element such as, for example, but not limited to, a cable, line or strap, a winch drive assembly, and a drum assembly.

In an embodiment, the winch comprises a winch cable, line or strap, a motor, a gear system, at least one solenoid, a drum assembly, a fairlead and a clutch.

In an embodiment, the winch cable, line or strap comprises a load hook.

In an embodiment, the winch drive assembly and drum assembly are mounted within the actuator housing; wherein the load hook is releasably connected to the first support structure and the cable is connected between the drum assembly and the load hook; and wherein the winch drive assembly comprises a drive motor.

In an embodiment, the apparatus further comprises an actuator switch that is operably connected to the actuator for starting or halting an actuation of the actuator between two of the first, second and third positions.

In an embodiment, the apparatus further comprises an actuator control system that is operably connected to a driving portion of the actuator for controlling an actuation of the actuator.

In an embodiment, the actuator control system comprises a first control element that is mounted within the actuator housing and a second control element that is positioned on or within the vehicle, wherein each of the first and second control elements are operably connected via a cable connection, and wherein each of the first and second control elements comprises an integrated controller.

In an embodiment, the actuator control system is a remote-control system comprising a first control element that is mounted within the actuator housing and a second control element that is positioned on or within the vehicle, each of the first and second control elements comprising a receiver-transmitter element and an integrated controller connected to the receiver-transmitter element.

In an embodiment, the trailer support comprises a receiving element that is configured to selectively receive the at least one first contact member of the first support structure for releasably coupling the trailer support to the apparatus frame.

In an embodiment, the receiving element is shaped and/or sized to receive the at least one contact member of the first support structure.

In an embodiment, the receiving element is shaped and/or sized to matingly receive the at least one contact member of the first support structure.

In an embodiment, the receiving element comprises a receiving channel that is configured to receive the at least one first contact member of the first support structure.

In an embodiment, the receiving channel is shaped and/or sized to receive the at least one first contact member of the first support structure.

In an embodiment, the trailer support comprises at least one hook-shaped member projecting from the trailer support.

In an embodiment, the at least one hook-shaped member projecting from the trailer support defines a channel portion wherein the channel portion defines the receiving channel of the trailer support.

In an embodiment, the at least one hook-shaped member projecting from the trailer support is a plurality of hook-shaped members projecting from the trailer support.

In an embodiment, the plurality of hook-shaped members projecting from the trailer support is a pair of hook-shaped members projecting from the trailer support.

In an embodiment, each of the hook-shaped members of the plurality of hook-shaped members defines a channel portion, and wherein the channel portions of the plurality of hook-shaped members collectively define the receiving channel of the trailer support.

In an embodiment, the trailer support further comprises a support surface engagement element configured to selectively engage a support surface, and a trailer engagement element configured to selectively engage a forward end portion of a trailer.

In an embodiment, the trailer engagement element comprises a stepped assembly having a front end, a back end, a top, and a bottom, the top of the stepped assembly providing a plurality of landing areas for the forward end portion of the trailer; and the support surface engagement element comprises a leg assembly comprising a plurality of supporting legs, a front support, and a back support, wherein the front end of the stepped assembly is connected to the front support and the back end of the stepped assembly is connected to the back support; wherein the receiving element has a first end, and a second end that is connected to the stepped assembly.

In an embodiment, the apparatus frame comprises a separable mounting assembly for mounting the apparatus frame to the vehicle.

In an embodiment, the mounting assembly comprises a pair of vertical bars which are each mounted to a mounting plate, wherein each vertical bar of the mounting assembly comprises at least one through-aperture and each vertical member of the apparatus frame comprises at least one connecting aperture that corresponds to the at least one through aperture of the vertical bar; at least one connecting aperture and at least one through-aperture being correspondingly sized to receive a fastener elements therethrough for securing the vertical bar of the mounting assembly to the vertical member of the apparatus frame.

In an embodiment, the trailer support is a shuntable trailer support; and wherein the vehicle is a shunt truck.

In another aspect, there is provided an apparatus for manipulating and/or maneuvering a trailer support, the apparatus being mounted to a vehicle for positioning the apparatus near the trailer support and the apparatus comprising an apparatus frame mounted to the vehicle, a first support structure that comprises at least one first contact member, the first support structure being movably mounted to the apparatus frame for movement between first, second, and third positions relative to the apparatus frame, the at least one first contact member being configured such that when the apparatus is positioned near to the trailer support and when the first support structure is moved from the first position to the second position, the at least one first contact member is releasably received by the trailer support for releasably coupling the trailer support to the apparatus frame, a second support structure that is mounted to the apparatus frame and that comprises at least one second contact member that is configured to contact the trailer support while the trailer support is releasably coupled to the apparatus frame, and an actuator connected to the apparatus frame and to the first support structure for driving an actuation of the first support structure from the first position to the second position, and from the second position to the third position such that the apparatus lifts the releasably coupled trailer support relative to the vehicle.

In an embodiment, the at least one first contact member being shaped and/or sized such that when the apparatus is positioned near to the trailer support and when the first support structure is moved from the first position to the second position, the at least one first contact member is releasably received by the trailer support for releasably coupling the trailer support to the apparatus frame.

In an embodiment, the at least one second contact member is shaped and/or sized to contact the trailer support while the trailer support is releasably coupled to the apparatus frame.

In another aspect, there is provided a apparatus for lifting a trailer support from a support surface, the apparatus being mounted to a vehicle and comprising an apparatus frame that is mounted to the vehicle, a first support structure that comprises at least one first contact member, the first support structure being movably connected to the apparatus frame, and the at least one first contact member being configured such that when the apparatus is moved to contact the trailer support by the vehicle, the at least one first contact member contacts and is releasably received by the trailer support for releasably coupling the trailer support to the apparatus frame, a second support structure that comprises at least one second contact member, and which is mounted to the apparatus frame such that when the apparatus is moved to contact the trailer support by the vehicle, the at least one second contact member contacts the trailer support at a location below where the at least one first contact member contacts and is releasably received by the trailer support, and an actuator connected to at least one of the first contact member and the first support structure for driving: an actuation of the first support structure from a first position to a second position relative to the apparatus frame such that the trailer support becomes releasably coupled to the apparatus frame, and an actuation of the first support structure from the second position to a third position relative to the apparatus frame such that the apparatus lifts the releasably coupled trailer from the support surface.

In an embodiment, the at least one first contact member is shaped and/or sized such that when the apparatus is moved to contact the trailer support by the vehicle, the at least one first contact member contacts, and is releasably received by, the trailer support for releasably coupling the trailer support to the apparatus frame.

In another aspect, there is provided a trailer support comprising a support surface engagement element configured to selectively engage a support surface, a trailer engagement element configured to selectively engage a forward end portion of a trailer; and a receiving element configured to selectively receive at least one contact member of an apparatus mounted to a vehicle for releasably coupling the trailer support to the apparatus for manipulating and/or maneuvering the trailer support relative to the support surface.

In an embodiment, the receiving element is shaped and/or sized to receive the at least one contact member of the apparatus.

In an embodiment, the receiving element is shaped and/or sized to matingly receive the at least one contact member of the apparatus.

In an embodiment, the receiving element comprises a receiving channel that is configured to receive the at least one contact member of the apparatus.

In an embodiment, the receiving channel is shaped and/or sized to receive the at least one contact member of the apparatus.

In an embodiment, the receiving element has a first end, and a second end that is connected to the trailer support.

In an embodiment, the first end of the receiving element is a free end.

In an embodiment, receiving element comprises at least one hook-shaped member projecting from the trailer support.

In an embodiment, the at least one hook-shaped member projecting from the trailer support defines a channel portion wherein the channel portion defines the receiving channel of the trailer support.

In an embodiment, the at least one hook-shaped member projecting from the trailer support is a plurality of hook-shaped members projecting from the trailer support.

In an embodiment, the plurality of hook-shaped members projecting from the trailer support is a pair of hook-shaped members projecting from the trailer support.

In an embodiment, each of the hook-shaped members of the plurality of hook-shaped members defines a channel portion, and wherein the channel portion of the plurality of hook-shaped members collectively define a receiving channel of the trailer support.

In an embodiment, the receiving channel of the trailer support selectively receives at least one contact member of an apparatus for releasably coupling the trailer support to the apparatus for manipulating and/or maneuvering the trailer support relative to the support surface.

In an embodiment, the trailer engagement element comprises a stepped assembly having a front end, a back end, a top, and a bottom, the top of the stepped assembly providing a plurality of landing areas for a forward end of a trailer.

In an embodiment, the second end of the receiving element is connected to the stepped assembly.

In an embodiment, the support surface engagement element comprises a leg assembly comprising a plurality of supporting legs, a front support, and a back support, wherein the front end of the stepped assembly is connected to the front support and the back end of the stepped assembly is connected to the back support.

In another aspect, there is provided a trailer support comprising a support surface engagement element configured to selectively engage a support surface, a trailer engagement element configured to selectively engage a forward end portion of a trailer; and a receiving element configured to selectively receive at least one contact member of a vehicle for releasably coupling the trailer support to the vehicle for manipulating and/or maneuvering the trailer support relative to the support surface.

In an embodiment, the receiving element is shaped and/or sized to receive the at least one contact member of the vehicle.

In an embodiment, the receiving element is shaped and/or sized to matingly receive the at least one contact member of the vehicle.

In an embodiment, the receiving element comprises a receiving channel that is configured to receive the at least one contact member of the vehicle.

In an embodiment, the receiving channel is shaped and/or sized to receive the at least one contact member of the vehicle.

In an embodiment, the receiving channel comprises a pair of receiving tubes that are positioned along the trailer support to extend between the front and rear of the trailer support.

In an embodiment, each receiving tube of the pair of receiving tubes define a receiving slot for a contact member of a vehicle.

In an embodiment, the contact member of the vehicle is a fork of a forklift.

In an embodiment, each of the pair of receiving tubes is mounted to the trailer support and is shaped and/or sized and spaced apart from the other of the pair of receiving tubes such that a pair of forks of a forklift can be advanced towards and inserted into the pair of receiving tubes such that the pair of forks are removably retained in the pair of receiving tubes and the trailer support be releasably coupled to the forklift.

In an embodiment, when the trailer support is releasably coupled to the vehicle with the pair of forks removably retained in the pair of receiving tubes, the trailer support can be manipulated and/or maneuvered by the forklift, in an embodiment, pushed along a support surface, in another embodiment, lifted off a support surface by the forks of the forklift and carried along above the support surface by the forklift moving forward or reversing, and in another embodiment, lowered by the forks of the forklift.

In an embodiment, the pair of receiving tubes are a pair of rectangular metal tubes.

In an embodiment, the pair of rectangular metal tubes are mounted to an underside of each of the front cross support and rear cross support of the trailer support and are sized to extend from at least a rearmost surface of the rear cross support of the trailer support to a frontmost surface of the front cross support of the trailer support.

In an embodiment, the trailer engagement element comprises a stepped assembly having a front end, a back end, a top, and a bottom, the top of the stepped assembly providing a plurality of landing areas for a forward end of a trailer.

In an embodiment, the second end of the receiving element is connected to the stepped assembly.

In an embodiment, the support surface engagement element comprises a leg assembly comprising a plurality of supporting legs, a front support, and a back support, wherein the front end of the stepped assembly is connected to the front support and the back end of the stepped assembly is connected to the back support.

In another aspect, there is provided a combination trailer support and apparatus for manipulating and/or maneuvering the trailer support, the apparatus for mounting to a vehicle for positioning the apparatus near the trailer support, the apparatus comprising: an apparatus frame for mounting to the vehicle; a first support structure comprising at least one first contact member, the first support structure being movably mounted to the apparatus frame for movement between at least a first position and a second position relative to the apparatus frame, the at least one first contact member being configured for being releasably received by the trailer support for releasably coupling the trailer support to the apparatus frame when the first support structure is moved from the first position to the second position; and an actuator connected to the apparatus frame and to the first support structure for driving an actuation of the first support structure from the first position to the second position for releasably coupling the trailer support to the apparatus frame, the trailer support comprising a receiving element configured to selectively receive the at least one first contact member for releasably coupling the trailer support to the apparatus frame, a support surface engagement element configured to selectively engage a support surface, and a trailer engagement element configured to selectively engage a forward end portion of a trailer.

In an embodiment, the trailer engagement element comprises a stepped assembly having a front end, a back end, a top, and a bottom, the top of the stepped assembly providing a plurality of landing areas for the forward end portion of the trailer; and the support surface engagement element comprises a leg assembly comprising a plurality of supporting legs, a front support, and a back support, wherein the front end of the stepped assembly is connected to the front support and the back end of the stepped assembly is connected to the back support; wherein the receiving element has a first end, and a second end that is connected to the stepped assembly.

The present invention provides an easy-to-use, reliable trailer support that inhibits a trailer from tipping over, and which does not require direct operator interaction to engage the support with, or disengage the support from, the trailer.

The present invention also provides an apparatus that can better manipulate and/or maneuver the trailer supports within loading facilities, where the apparatus does not have to reverse or back-up the support along the grounds. It is therefore an object of the disclosure to provide a novel and inventive apparatus for manipulating and/or maneuvering a trailer support.

The present invention further provides a trailer support that may be positioned by engaging the front of an auxiliary vehicle and deployed by the auxiliary vehicle driving forward and toward a front of the semi-trailer, rather than reversing or backing-up the auxiliary vehicle to position the trailer support.

### BRIEF DESCRIPTION OF THE DRAWINGS

Embodiments will now be described, by way of example only, with reference to the attached Figures, wherein:

FIG. 1 shows a high-level diagram of an embodiment of the apparatus of the present invention mounted on a vehicle, and an embodiment of the trailer support of the present invention that can be releasably coupled to the apparatus;

FIG. 2 shows an isometric view of the apparatus of FIG. 1;

FIG. 3A is a side view of an embodiment of the apparatus, where the first support structure of the apparatus is in a first position;

FIG. 3B is a side view of the embodiment of the apparatus in FIG. 3A, with the first support structure of the apparatus in a second position;

FIG. 3C is a side view of the embodiment of the apparatus in FIG. 3A, with the first support structure of the apparatus in a third position;

FIG. 3D is a close-up, partial side view of the embodiment of the apparatus in FIG. 3A, with the first support structure of the apparatus in a first position;

FIG. 3E is a close-up, partial side view of the embodiment of the apparatus in FIG. 3A, with the first support structure of the apparatus in a second position;

FIG. 3F is a close-up, partial side view of the embodiment of the apparatus in FIG. 3A, with the first support structure of the apparatus in a third position;

FIG. 4 is a partial, isometric view of the apparatus of FIG. 2 comprising a first support structure and bearings mounted to the apparatus frame;

FIG. 5A is a partial, isometric view of the apparatus of FIG. 2 comprising the second support structure and a mount of the mounting assembly;

FIG. 5B is a partial, rear, isometric view of the apparatus of FIG. 2 comprising the second support structure and the mounting assemblies;

FIG. 5C is a partial view of the apparatus of FIG. 2 comprising the apparatus frame and a mount of the mounting assembly;

FIG. 6 is a partial, isometric view of the lock hook and the first contact member of the apparatus of FIG. 2;

FIG. 7 is a section-view of the actuator and actuator housing of the apparatus of FIG. 2;

FIG. 8 shows an isometric view of the apparatus of FIG. 2 where the first support structure is in the third position relative to the apparatus frame;

FIG. 9A is a rear, isometric view of an embodiment of the trailer support;

FIG. 9B is an isometric view of the embodiment of the trailer support in FIG. 9A;

FIG. 9C is a side-view of an embodiment of the stepped inner or outer plate of the trailer support in FIG. 9A;

FIG. 9D is a partial, isometric view of the support legs of the trailer support of FIG. 9A;

FIG. 10A is a front view of a bumper and frame member of the trailer support of FIG. 9A;

FIG. 10B is an isometric view of a bumper and frame member of the trailer support of FIG. 9A;

FIG. 11 shows an isometric view of the trailer support and apparatus of FIG. 1 where the apparatus is mounted on the vehicle and the first support structure is in the first position relative to the apparatus frame;

FIG. 12 shows a partial, isometric view of the mounting assembly mounted on a bumper of the vehicle in FIG. 11;

FIG. 13A shows an isometric view of the apparatus of FIG. 11, mounted on the vehicle with the first support structure in the first position;

FIG. 13B shows an isometric view of the apparatus of FIG. 11, mounted on the vehicle with the first support structure in the second position;

FIG. 13C shows an isometric view of the apparatus of FIG. 11, mounted on the vehicle with the first support structure in the third position;

FIG. 14A shows a side view of the apparatus of FIG. 11, mounted on the vehicle with the first support structure in the first position;

FIG. 14B shows a side view of the apparatus of FIG. 11, mounted on the vehicle with the first support structure in the second position;

FIG. 14C shows a side view of the apparatus of FIG. 11, mounted on the vehicle with the first support structure in the third position;

FIG. 15 shows a straight on view of the diagram of FIG. 1 comprising the apparatus mounted on a vehicle, and the trailer support that can be releasably coupled to the apparatus;

FIG. 16A shows an isometric view of an embodiment of the apparatus that comprises a first contact member with end caps;

FIG. 16B shows a close-up view of the apparatus and end caps of the first contact member of FIG. 16A;

FIG. 17A shows an isometric view of an embodiment of the apparatus that comprises limiting devices and contact plates;

FIG. 17B shows a close-up view of the apparatus and limiting devices of FIG. 17A;

FIG. 17C shows a close-up view of the apparatus contact plates of FIG. 17A;

FIG. 18A shows an isometric view of an embodiment of the trailer support that comprises a securing tab;

FIG. 18B shows a bottom-up view of the embodiment of the trailer support and securing tab of FIG. 18A; and

FIG. 18C shows a side-view of the embodiment of the trailer support and securing tab of FIG. 18A.

FIG. 19A shows a rear, isometric view of an additional embodiment of the trailer support;

FIG. 19B shows an isometric view of the embodiment of the trailer support in FIG. 19A;

FIG. 19C shows a rear view of the embodiment of the trailer support in FIG. 19A;

FIG. 19D shows a partial, isometric view of the support legs of the trailer support of FIG. 19A;

FIG. 20A shows an isometric view of the lifting apparatus where the first support member is in the first position relative to the apparatus frame;

FIG. 20B shows an isometric view of the embodiment of the lifting apparatus in FIG. 20A, with the first support structure of the lifting apparatus in the second position;

FIG. 20C shows an isometric view of the embodiment of the lifting apparatus in FIG. 20A, with the first support structure of the lifting apparatus in the third position;

FIG. 21 shows a rear, perspective view of the embodiment of the lifting apparatus in FIG. 20A, where the lifting apparatus is connected to the mounting assembly;

FIG. 22 shows a perspective view of the embodiment of the mounting assembly in FIG. 21;

FIG. 23A shows a close-up, perspective view of the lifting apparatus of FIG. 19A, where the lifting apparatus comprises a control system and control system housing;

FIG. 23B shows a close-up, perspective view of the lifting apparatus of FIG. 23A, where the first support member is in the second position relative to the apparatus frame;

FIG. 24A shows a close-up view of an embodiment of the limiting device assembly on the lifting apparatus of FIG. 20A, where the first support structure is in the first position;

FIG. 24B shows a close-up view of an embodiment of the limiting device assembly on the lifting apparatus of FIG. 20A, where the first support structure is in the second position;

FIG. 24C shows a close-up view of the limiting device assembly of the embodiment of the lifting apparatus in FIG. 20A, where the first support structure is in the third position;

FIG. 25 shows a close-up view of the actuator of the embodiment of the lifting apparatus in FIG. 20A, where the actuator comprises a nylon strap;

FIG. 26 shows a perspective view of the connecting apertures of the embodiment of the lifting apparatus in FIG. 20A, where a quick release pin is mounted through one of the connecting apertures;

FIG. 27A shows a perspective view of the embodiment of the lifting apparatus in FIG. 20A, where the lifting apparatus is secured to the mounting assembly;

FIG. 27B shows a close-up view of the embodiment of the lifting apparatus in FIG. 20A, where the lifting apparatus is secured to the mounting assembly;

FIG. 27C shows a perspective view of the embodiment of the lifting apparatus in FIG. 20A, where the lifting apparatus is tilted forward relative to the mounting assembly; and

FIG. 27D shows a close-up view of the embodiment of the lifting apparatus in FIG. 20A, where the lifting apparatus is tilted forward relative to the mounting assembly.

### DETAILED DESCRIPTION OF THE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures, and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout comprise their plural forms, and vice versa; similarly, gendered pronouns comprise their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may comprise more, fewer, or other steps. Additionally, steps may be performed in any suitable order. As used in this document, “each” refers to each member of a set or each member of a subset of a set.

The embodiments of the invention described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

### Apparatus for Manipulating and/or Maneuvering a Trailer Support

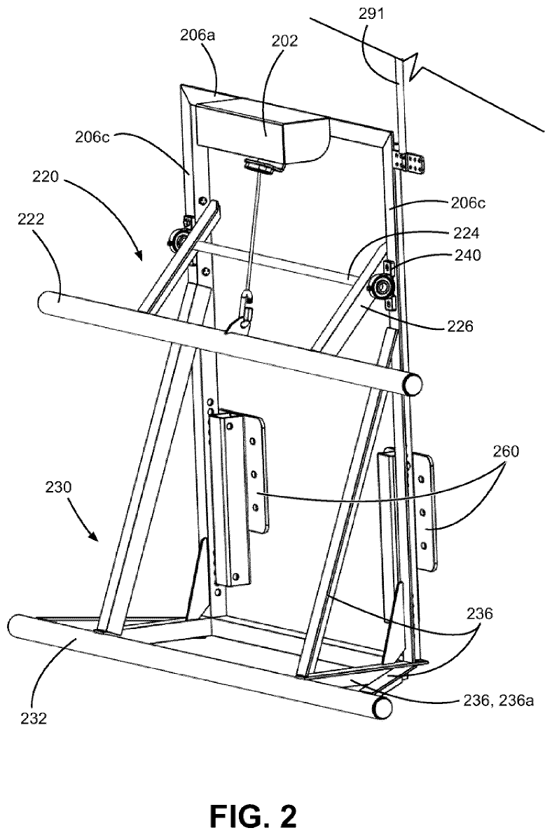

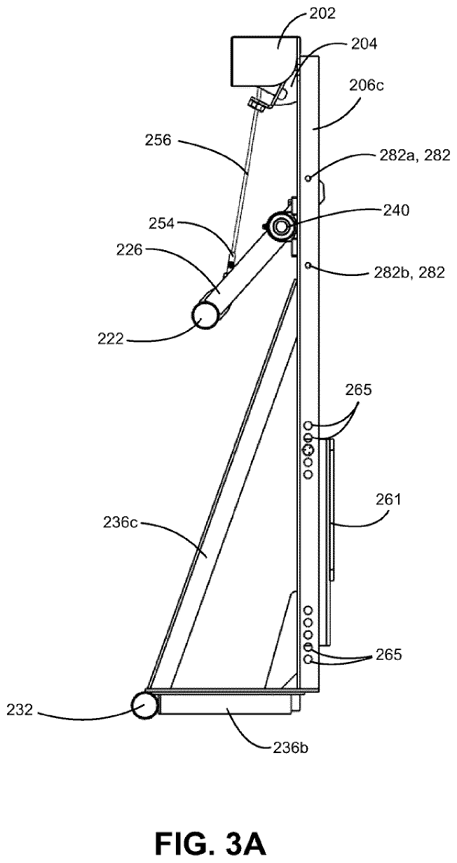

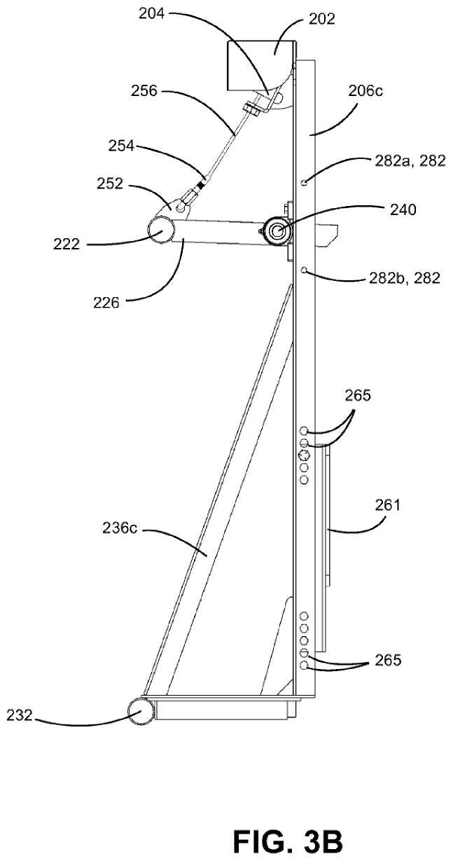

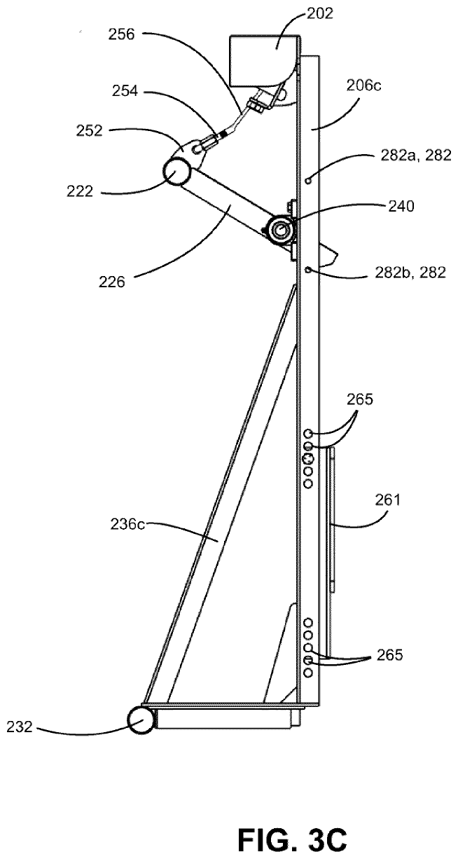

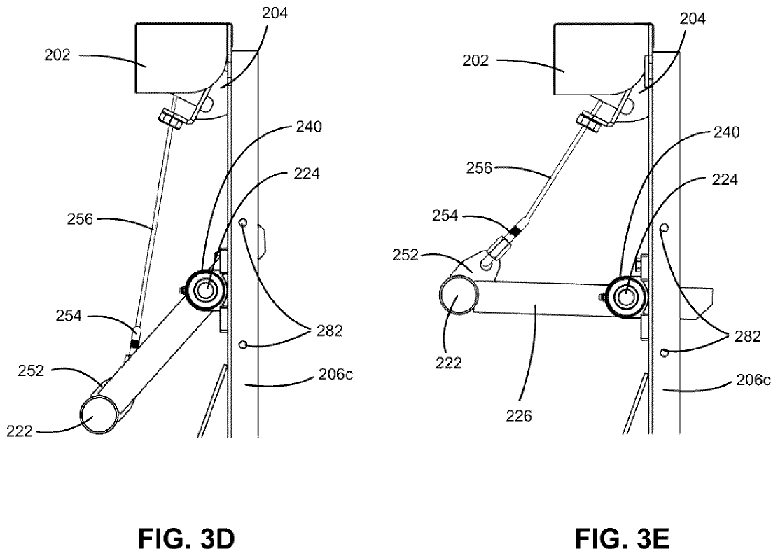

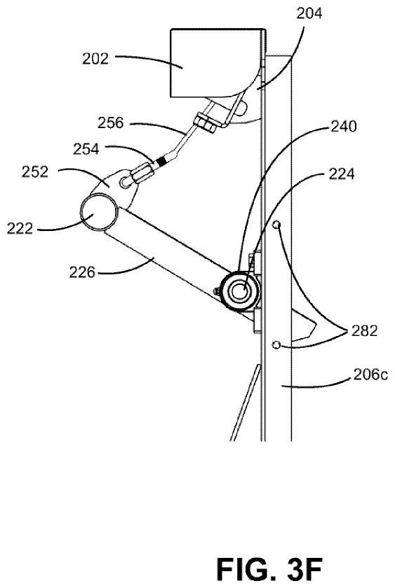

Referring to FIGS. 2 and 3A to 3F the present disclosure provides an apparatus 110 for manipulating and/or maneuvering a trailer support 120, the apparatus 110 being mounted to a vehicle 130 for positioning the apparatus 110 near the trailer support 120, and the apparatus 110 comprising an apparatus frame 206 mounted to the vehicle 130, a first support structure 220, a second support structure 230 and an actuator 204. The first support structure 220 comprises at least one first contact member 222 and the first support structure 220 is movably mounted to the apparatus frame 206 for movement between at least first, second, and third positions relative to the apparatus frame 206. The at least one first contact member 222 is configured, such as, for example, shaped and/or sized, such that when the apparatus 110 is positioned near to the trailer support 120 and when the first support structure 220 is moved from the first position (i.e., the rest, disengaged or uncoupled position) to the second position (i.e., the releasably engaged or releasably coupled position), the at least one first contact member 222 is releasably received by the trailer support 120 for releasably coupling the trailer support 120 to the apparatus frame 206. The second support structure 230 is mounted to the apparatus frame 206 and comprises at least one second contact member 232 that is configured, such as, for example, shaped and/or sized, to contact the trailer support 120. Contact of the at least one second contact member 232 with the trailer support 120 indicates to the operator that the at least one first contact member 222 is properly aligned with the trailer support 120 such that the trailer support 120 can be releasably coupled to the apparatus frame 206. The actuator 204 is connected to the apparatus frame 206 and to the first support structure 220 for driving an actuation of the first support structure 220 from the first position (See FIGS. 3A and 3D) to the second position (See FIGS. 3B and 3E). When the trailer support 120 is releasably coupled to the apparatus 110, the trailer support 120 can be maneuvered along the support surface upon which the trailer support 120 rests by, for example, the vehicle 130 driving forward and pushing the trailer support 120 along the support surface or the vehicle 130 reversing and pulling the trailer support 120 along the support surface. The actuator 204 is also connected for driving an actuation of the first support structure 220 from the second position to the third position (i.e., the lifting position) (See FIGS. 3C and 3F) such that the apparatus 110 lifts the releasably coupled trailer support 120 relative to the vehicle 130, off the support surface on which the trailer support 120 rests.

In an embodiment, the vehicle 130 to which the apparatus 110 is mounted is a shunt truck.

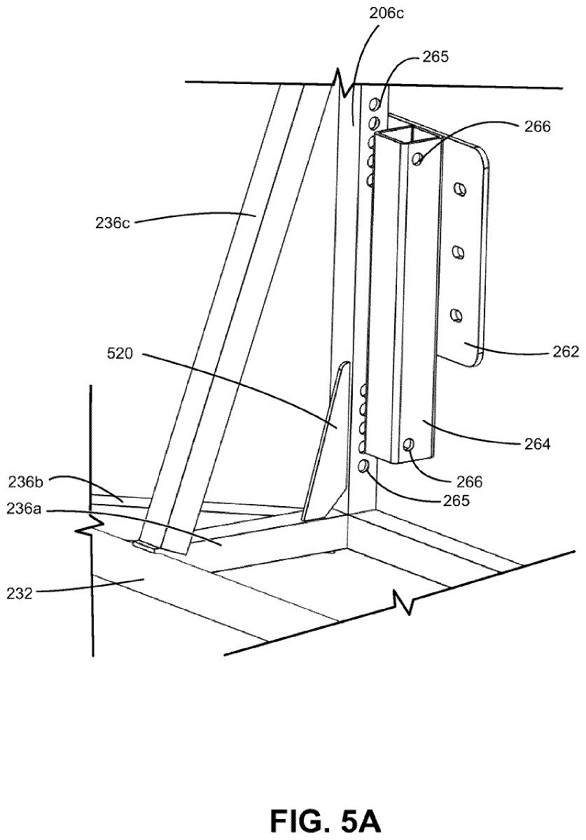

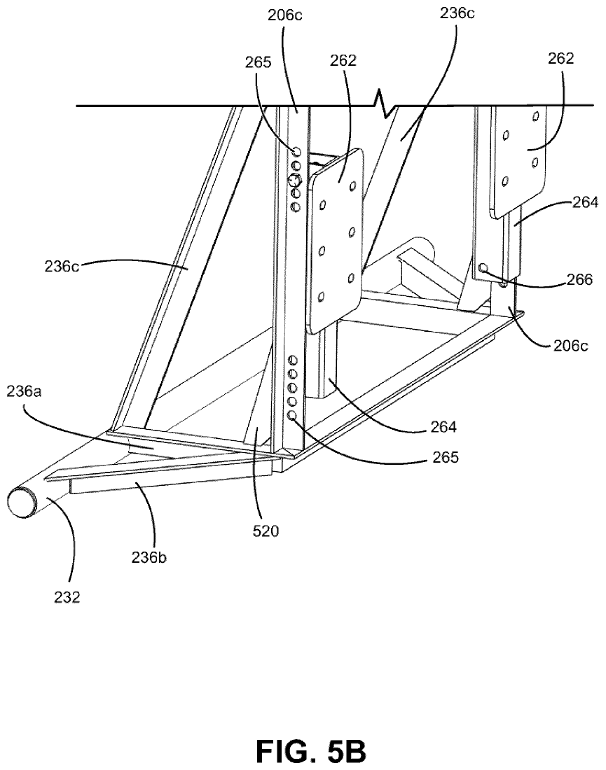

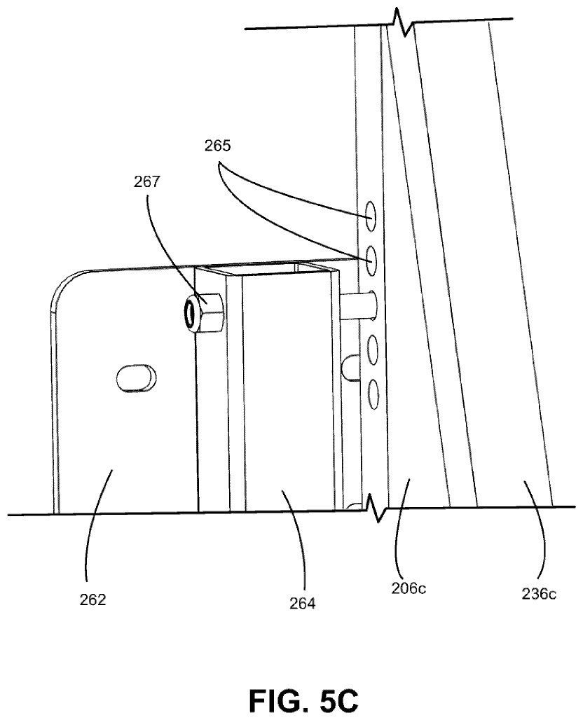

In an embodiment such as that provided in FIGS. 5A to 5C, a mounting assembly 260 is provided for removably mounting the apparatus 110 to the vehicle 130. In an embodiment, the apparatus frame 206 of the apparatus 110 is mounted to a mounting surface of the vehicle 130 via the mounting assembly 260. The apparatus frame 206 of the apparatus 110 is formed to be mounted to a mounting surface of the vehicle 130 via the mounting assembly 260. The mounting assembly 260 is formed to support the apparatus frame 206 on the vehicle 130. The apparatus frame 206 is generally formed to define at least one planar surface. When the apparatus frame 206 is mounted to the mounting surface of the vehicle 130 via the mounting assembly 260, the planar surface at least partially contacts the mounting assembly 260. In this way, the apparatus frame 206 is supported against the mounting assembly 260 to prevent relative twisting therebetween.

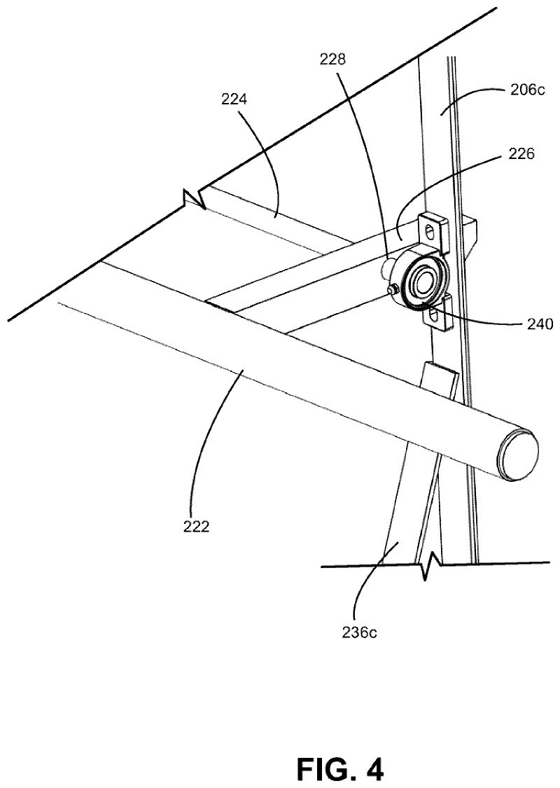

In some embodiments of the present invention, the mounting surface of the vehicle 130 comprises at least a portion of a front bumper 132 of the vehicle 130, and the apparatus frame 206 of the apparatus 110 is removably mounted to the portion of the front bumper 132 of the vehicle 130. apparatus In an embodiment such as that provided in FIGS. 2 to 8, the apparatus frame 206 is a rectangular apparatus frame that comprises a substantially horizontal top member 206a, a substantially horizontal bottom member 206b, and a pair of vertical members 206c. In a further embodiment, the at least one planar surface of the apparatus frame 206 is defined along rear surfaces of the top member 206a, bottom member 206b and pair of vertical members 206c of the apparatus frame 206.

In the specific embodiment shown in FIGS. 2 to 8, each member of the apparatus frame 206 is composed of metal angled bars such as angle iron.

In an embodiment, each vertical member 206c of the pair of vertical members 206c of the apparatus frame 206 comprises at least one connecting aperture 265. In the embodiments provided in FIGS. 3A to 3C and FIGS. 5A to 5C, lateral faces of the vertical members 206c of the apparatus frame 206 comprise at least one set of a plurality of connecting apertures 265 extending therethrough. In the specific embodiments in FIGS. 5A to 5C, each vertical member 206c comprises two sets of a plurality of connecting apertures 265, each of the two sets being vertically spaced relative to one another. Each of the connecting apertures 265 extend through the width of the vertical members 206c.

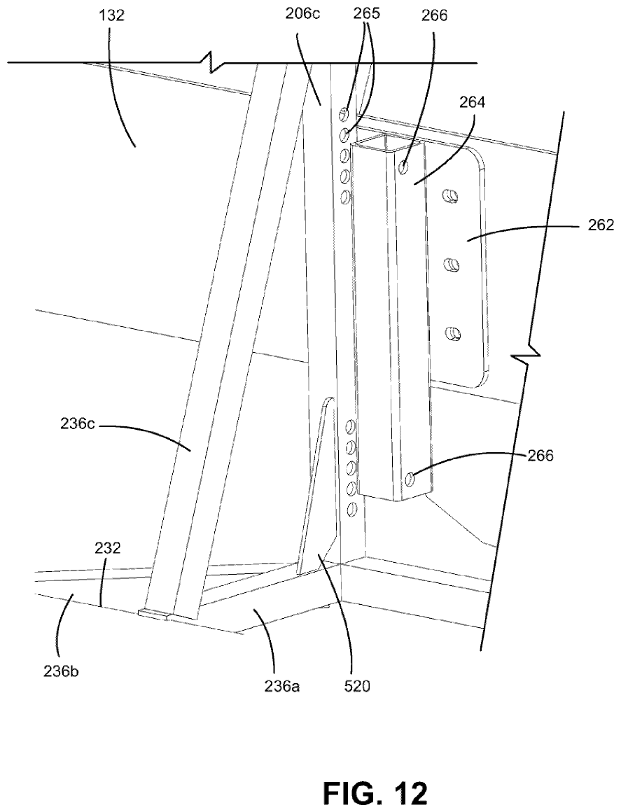

The mounting assembly 260 comprises a pair of mounts 261 that are removably connectable to the apparatus frame 206. As shown in FIG. 12, the pair of mounts 261 of the mounting assembly 260 are removably mountable to the mounting surface of the operating vehicle 130.

In the embodiment provided in FIG. 2 and 5A to 5C, the mounts 261 of the mounting assembly 260 comprise a pair of vertical bars 264 that are each mounted to a mounting plate 262.

In an embodiment, each vertical bar 264 of the mounting assembly 260 is welded to the corresponding mounting plate 262 of the mounting assembly 260.

In an embodiment, each vertical bar 264 of the mounting assembly 260 comprises at least one through-aperture 266 that corresponds to the at least one connecting aperture 265 of the vertical members of the apparatus frame 206. The connecting aperture 265 and the at least one through-aperture 266 are each sized to receive a fastener element for securing each vertical bar 264 to a corresponding vertical member 206c of the apparatus frame 206. In the specific embodiment provided in FIGS. 5A to 5C, the vertical bars 264 of the mounts 261 each comprise at least one through-aperture 266 in the form of two through-apertures 266 , one through-aperture 266 being defined on an upper half of the vertical bar 264 and the other through-aperture 266 defined on a lower half of the vertical bar 264. In this embodiment, the two through-apertures 266 of each vertical bar 264 correspond to the two sets of connecting apertures 265 of the vertical members 206c of the apparatus frame 206 provided in FIGS. 5A to 5C.

In this way, when the apparatus frame 206 is to be mounted to the mounts 261 of the mounting assembly 260, the vertical bars 264 of the mounts 261 are positioned parallel to the vertical members 206c of the apparatus frame 206. The upper and lower through-apertures 266 of each vertical bar 264 are aligned with the one connecting aperture 265 of the two sets of connecting apertures 265 in each of the vertical members 206c of the apparatus frame 206.

In an embodiment, each mounting plate 262 of the mounting assembly 260 comprises a plurality of through-holes which are sized to receive a fastener for securing the mounting plate 262 to the mounting surface of the vehicle 130. In an additional embodiment, where the mounting surface is the front bumper of the vehicle 130, the front bumper comprises a plurality of pre-formed apertures, and the plurality of through holes of each mounting plate 262 are positioned and sized to correspond to the pre-formed apertures in the front bumper of the vehicle 130.

In the specific embodiment shown in FIGS. 5A to 5C, the apparatus frame 206 is shown connected to the mounts 261 of the mounting assembly 260. The two sets of a plurality of connecting apertures 265 of the apparatus frame 206 are aligned with the through-apertures 266 of each vertical bar 264 of the mounts 261. As shown in FIG. 5C, a bolt or similar fastener element 267 is provided through a corresponding connecting aperture 265 and the through-apertures 266 of the vertical bar 264 to secure the mount 261 to the apparatus frame 206. The plurality of connecting apertures 265 in each of the two sets of connecting apertures 265 provides for adjustment of the relative position of mounts 261 and the apparatus frame 206. In this way, the mounts 261 can be repositioned relative to the apparatus frame 206 by removing the fastener element 267, realigning the through-apertures 266 of the mounts 261 with another pair of connecting apertures 265 of the two sets of connecting apertures 265, and re-inserting the fastener element 267.

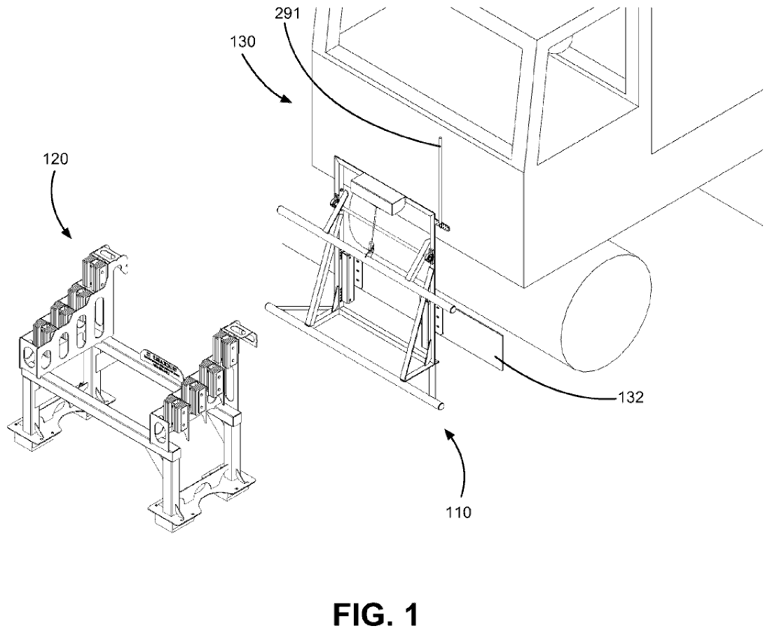

In an embodiment such as that provided in FIGS. 1 and 2, the apparatus 110 comprises at least one alignment body 291 that is positioned on the apparatus 110 to assist in the alignment of the apparatus 110 with the trailer support 120 when the trailer support 120 is to be releasably coupled to, and manipulated and/or maneuvered by, the vehicle 130 and the apparatus 110.

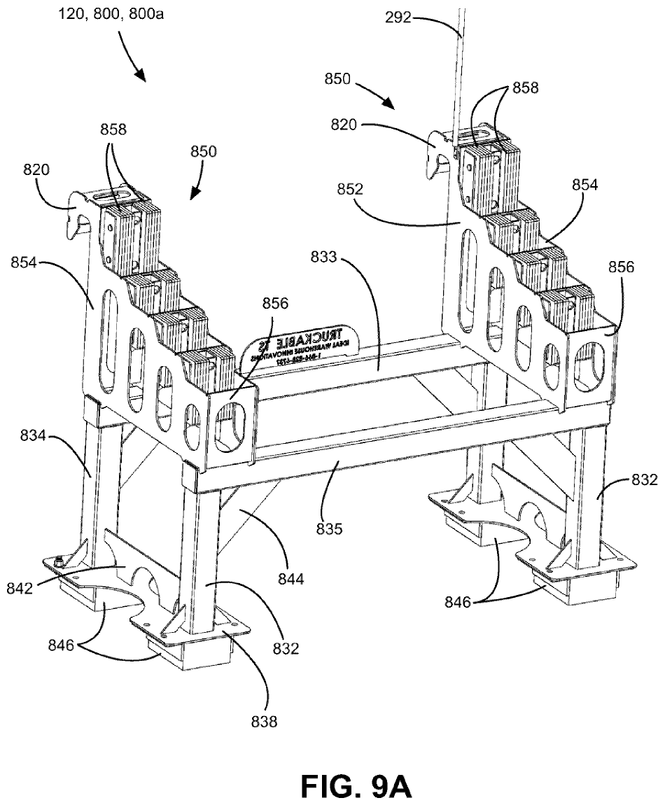

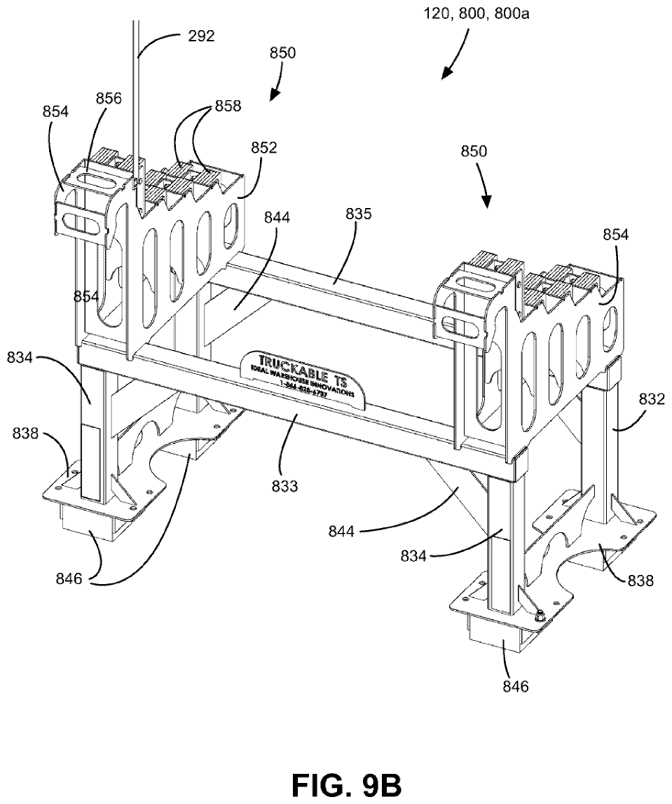

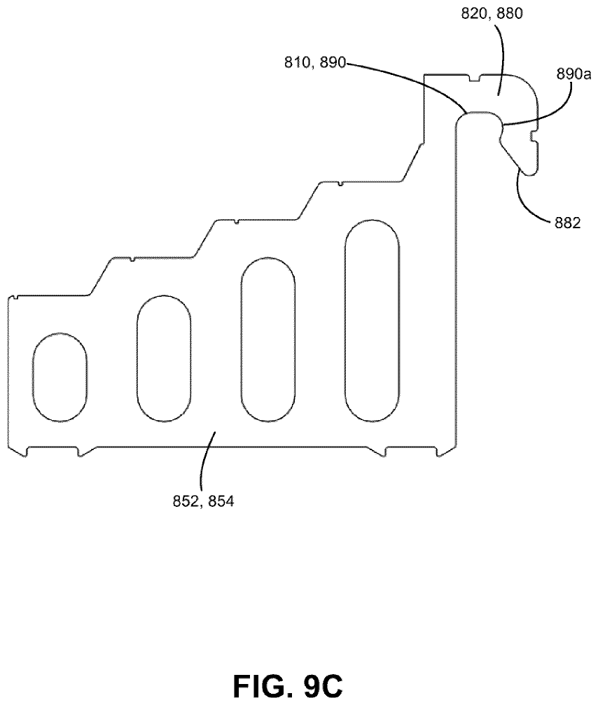

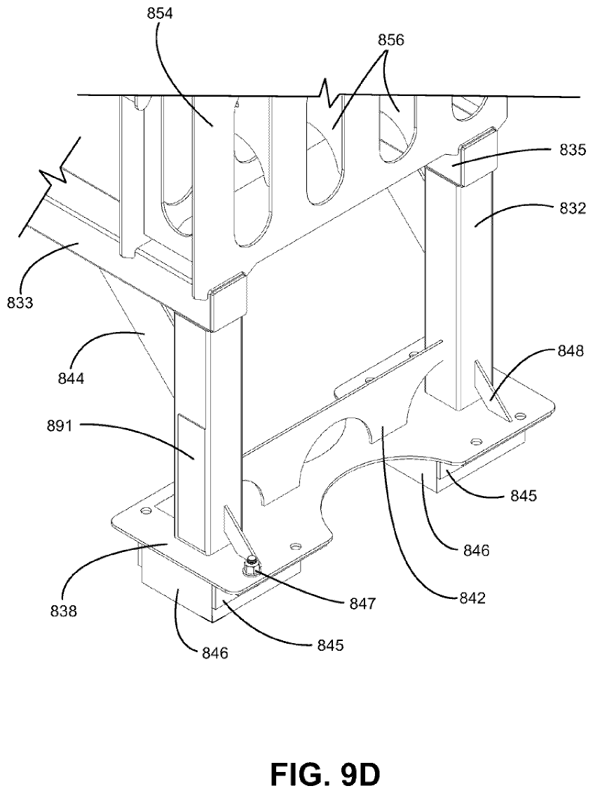

In an additional embodiment, as shown in FIGS. 9A, 9B, 11, 13A, 13B, 13C and 15, the trailer support 120 comprises an alignment body 292 that corresponds to the alignment body 291 of the apparatus 110.

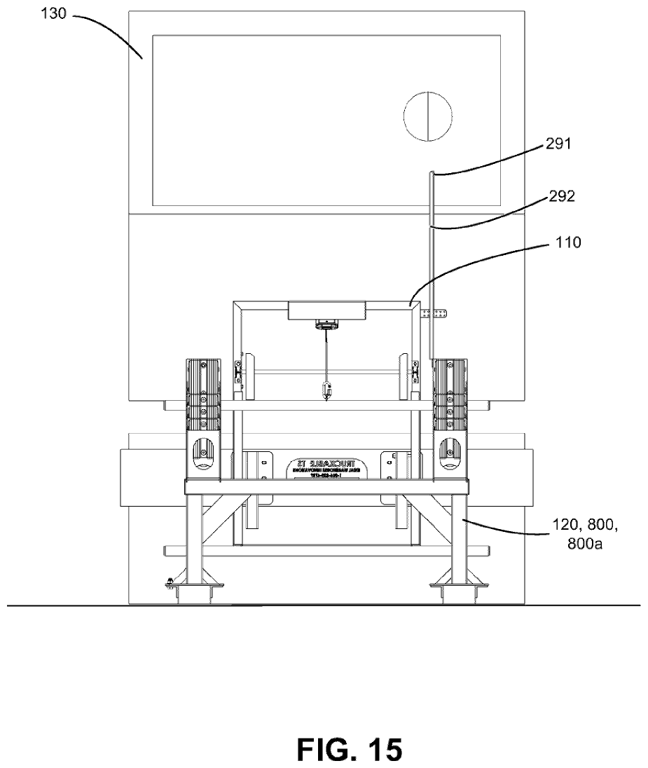

In an embodiment, the alignment bodies 291, 292 of the apparatus 110 and the trailer support 120, respectively, are relatively positioned such that when the apparatus 110 and trailer support 120 are properly aligned for releasably coupling the trailer support 120 to the apparatus 110, the alignment bodies 291, 292 are located in substantially the same position along the width of the apparatus frame 206, as shown in FIG. 15.

In the specific embodiments of FIGS. 1 and 2, the alignment body 191 is a vertical rod that is mounted to a side surface of one of the vertical members 206c of the apparatus frame 206.

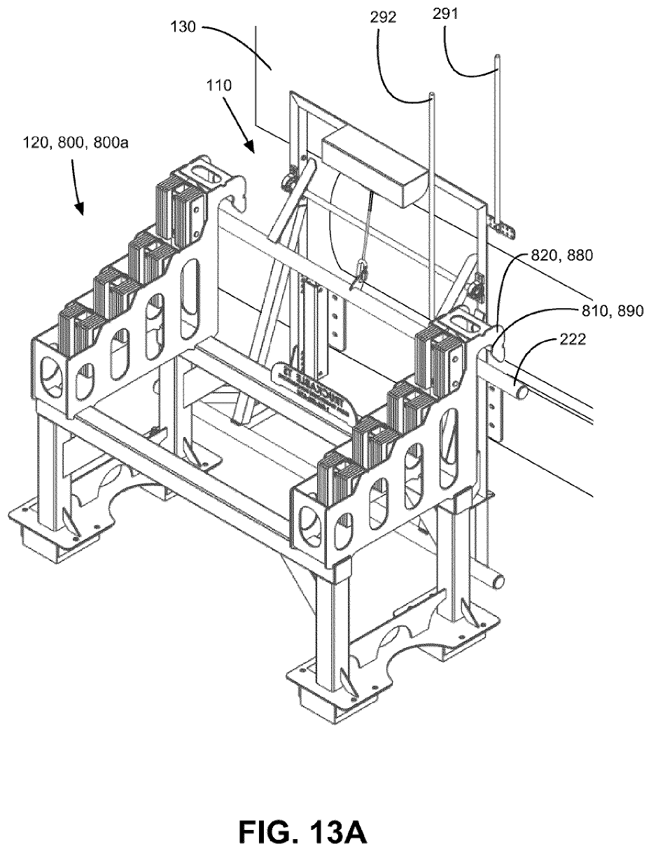

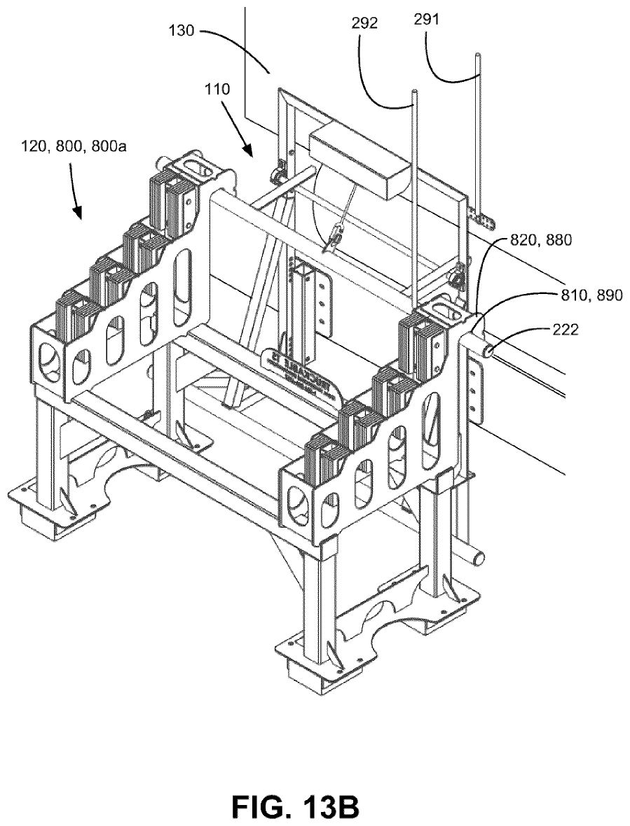

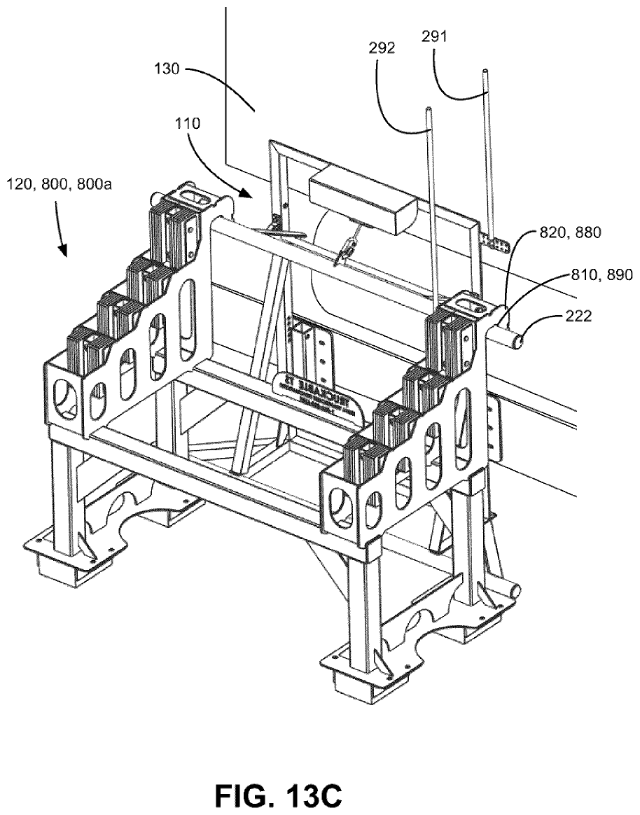

In the specific embodiments of FIGS. 13A to 13C, the alignment body 192 of the trailer support 120 is also a vertical rod that is mounted to the trailer support 120.

As disclosed previously, the apparatus 110 comprises the first support structure 220 that comprises at least one first contact member 222.

In an embodiment, the at least one first contact member 222 of the first support structure 220 is a substantially horizontal, first circular contact beam. The first circular contact beam may have a length that is greater than the width of apparatus 110 defined by outer vertical edges of the vertical members 206c of the apparatus frame 206.

As shown in FIGS. 3A to 3F, the first support structure 220 is pivotably mounted to the apparatus frame 206 for movement between first, second, and third rotational positions relative to the apparatus frame 206.

In an embodiment, the first support structure 220 is pivotably connected to the apparatus frame 206 at a location above the plurality of connecting apertures 265 of each vertical member 206c of the apparatus frame 206.

In an embodiment such as that provided in FIGS. 3A to 3F, the first support structure 220 is pivotably mounted to the apparatus frame 206. The first support structure 220 comprises a continuous first contact member 222, a substantially horizontal support rod 224 and a plurality of beam elements 226. A first end of each of the plurality of beam elements 226 is mounted to, and extends outward from, the support rod 224. A second end of each of the plurality of beam elements 226 is mounted to the first contact member 222 for supporting the first contact member 222.

In the specific embodiment provided in FIGS. 3A to 3F, the at least one first contact member 222 is the first circular contact beam, and the plurality of beam elements 226 comprise a pair of angle beams extending between the support rod 224 and the first circular contact beam. An end of each of the angle beams is welded to the first circular contact member, and each angle beam comprises a through-aperture 228 that is sized to receive a portion of the support rod 224 so as to form an assembly of the angle beams and the support rod 224. The angle beams and support rod 224 can be joined at these through-apertures 228 via welding such that support rod 224 and angle beams will pivot together relative to the apparatus frame 206. While angle beams are provided in this exemplary embodiment, it will be readily understood that various beam forms and shapes can be used to form the plurality of beam elements 226 of the first support structure 220 that extend between the support rod 224 and the first circular contact beam.

In an embodiment, the first support structure 220 is movably mounted to the apparatus frame 206 via a plurality of bearings 240.

Referring still to the specific embodiment provided in FIGS. 3A to 3F, the plurality of bearings 240 is a pair of bearings, where one of the pair bearings 240 is mounted on a vertical face of each vertical member 206c of the apparatus frame 206. The support rod 224 of the first support structure 220 is sized to extend between, and to be received in, each of the pair of bearings 240. The support rod 224 received in the bearings 240 defines a pivoting axis (P) about which the first support structure 220 is pivotable relative to the apparatus frame 206.

In an additional embodiment, each of the pair of bearings 240 is bolted to the corresponding vertical faces of the vertical members 206c of the apparatus frame 206.

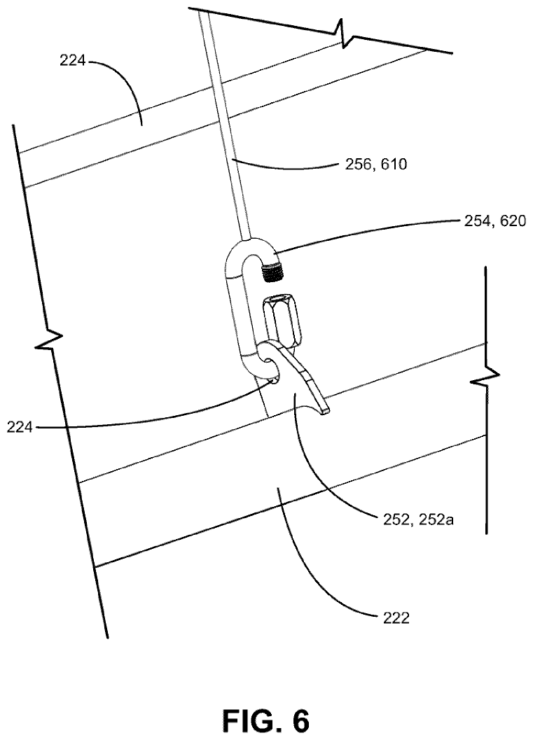

In an embodiment such as that provided in FIG. 6, the first support structure 220 comprises a connecting structure 252 for connecting the first support structure 220 to the actuator 204 of the apparatus 110. In the specific embodiment provided in FIG. 6, the first contact member 222 is the circular contact beam, and the actuator 204 comprises a load hook 254 and a load-bearing cable 256. The connecting structure 252 is a flange 252a that is welded to an outer surface of the circular contact beam and that extends radially outwards from the circular contact beam. The flange 252a comprises an aperture 252b that is sized to receive the load hook 254 that is connected to the load-bearing cable 256 of the actuator 204.

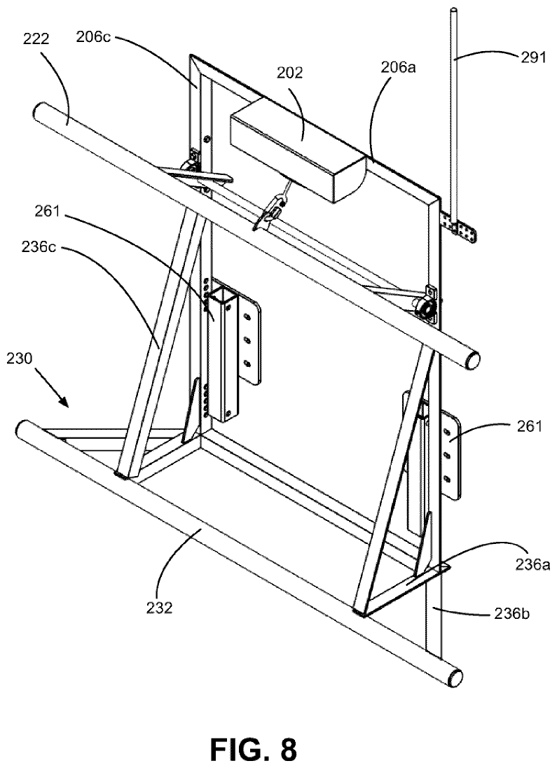

In an embodiment, the apparatus frame 206 comprises a plurality of hard stop bodies 282 for partially restricting movement of the first support structure 220 relative to the apparatus frame 206. As shown in FIGS. 2 and 8, the plurality of hard stop bodies 282 comprises a pair of upper hard stops 282a positioned on the apparatus frame 206 above the mounting location of the plurality of bearings 240, and a pair of lower hard stops 282b positioned on the apparatus frame 206 below the mounting location of the plurality of bearings 240.

In this way, the upper and low hard stops 282a, 282b define upper and lower limits of the pivoting motion of the first support structure 220 relative to the apparatus frame 206.

In the specific embodiment provided in FIGS. 2 and 8, the plurality of hard stop bodies 282 are a pair of bolts mounted at the corresponding upper and lower locations along each vertical beam 206c of the apparatus frame 206. As the plurality of beam elements 226 and the support rod 224 pivot about bearings 240, the bolts are positioned such that the plurality of beam elements 226 will abut against one of each pair of bolts when the first support structure 220 is at a maximum pivot in a particular direction.

Referring to FIGS. 2 and 8, due to the alignment of support rod 224 and bearings 240 being offset from the alignment of the hard stop bodies 282 on the vertical beams 206c, the pivoting of the first support structure 220 will be opposingly restricted by the hard stop bodies 282. When the first support structure 220 is pivoted to an uppermost pivoting position, i.e., the third position, the first support structure 220 will contact the lower hard stops 282b, and when the first support structure 220 is pivoted to its lowest pivoting position, i.e., the first position, the movable first support structure 220 will contact the upper hard stops 282a.

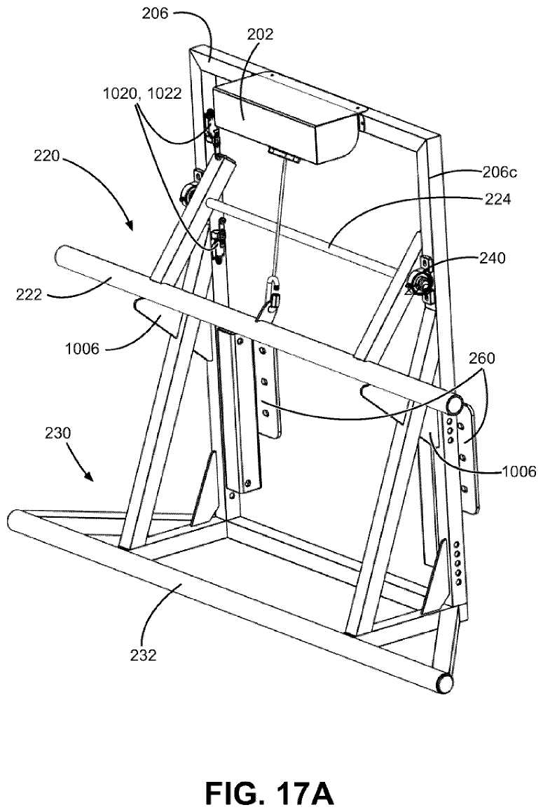

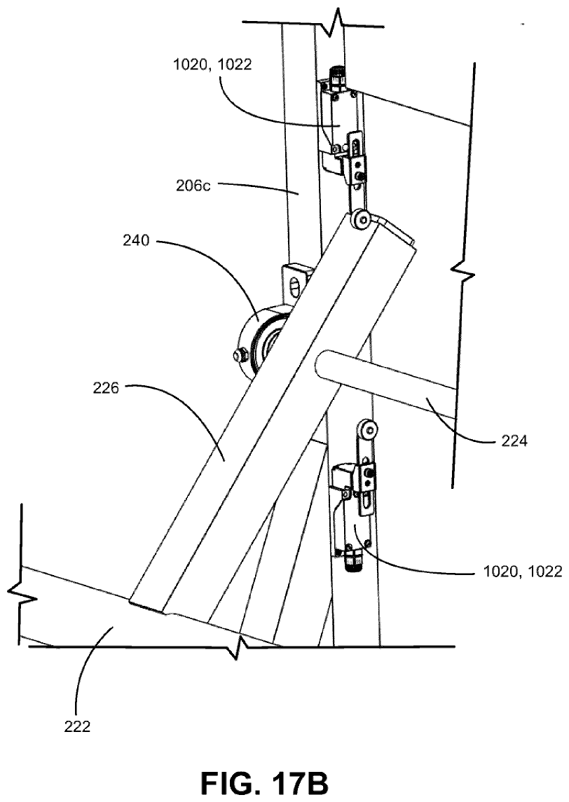

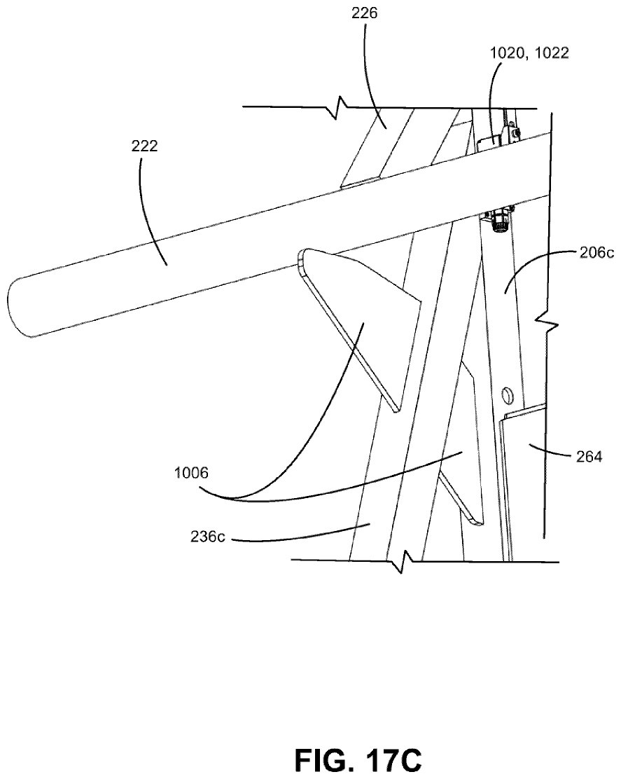

In an additional embodiment as provided in FIGS. 17A to 17C, the apparatus 110 comprises lower hard stops in the form of contact plates 1006. The contact plates 1006 are in the form of triangular metal plates that are mounted to the vertical members 406c of the apparatus frame 406 and extend upwards to define a lower limit. In this embodiment, when the first support structure 220 is in the first position relative to the apparatus frame 206, the first contact member 222 rests on a tip of the contact plate 1006.

In an additional embodiment also provided in FIGS. 17A to 17C, the apparatus comprises at least one limiting device 1020 that is connected on the apparatus and that is positioned to limit the movement of the first support structure in at least one direction relative to the apparatus frame 206. The at least one limiting device 1020 limits the movement of the first support structure 220 to prevent excessive movement or “over-travel” of the first support structure 220 in a particular direction relative to the apparatus frame 206.

In an embodiment, the at least one limiting device 1020 is mounted to the apparatus frame.

In the specific embodiment provided in FIGS. 17A to 17C, the limiting device 1020 is a pair of limit switches 1022 mounted to one of the vertical members 406c of the apparatus frame. The limit switches 1022 are mounted on the vertical member 406c and are spaced apart to define the vertical limits of the movement of the first support structure relative to the apparatus frame.

In this embodiment, the limit switch 1022 is connected to the control system of the apparatus. The limit switches 1022 function such that when the limit switch 1022 is contacted by the first support structure, the switch will be triggered, and a control signal will be send to the control system to halt the actuator 204 as it drives the motion of the first support structure 220. The limit switch 1022 can send a signal that overrides any input provided by an operator of the apparatus 110. In this way, the limit switch 1022 provides a hard-stop on the operation of the apparatus 110 regardless of the operator's input.

In an alternate embodiment, the at least one limiting device 1020 is incorporated directly within the actuator 204 of the apparatus 110. For example, the at least one limiting device 1020 is a limit switch 1022 that is internally mounted within the structure of the actuator 204.

As disclosed previously, the apparatus 110 comprises the second support structure 230 that comprises at least one second contact member 232 and that is fixedly mounted to the apparatus frame 206.

In an embodiment, the second support structure 230 is mounted to the apparatus frame 206 such that the second contact member 232 is provided on a bottom half of the apparatus frame 206. The second contact member 232 functions as a second contact point of the apparatus 110 for the trailer support 120 when the first contact member 222 is releasably received by the trailer support 120.

If the trailer support 120 is being maneuvered, for example slid, for example by being pushed, along a surface by the vehicle 130 when the apparatus 110 is mounted on the vehicle 130 and the trailer support 120 is releasably coupled to the apparatus 110, the second contact member 232 will provide a second point of applied force at a second height on the trailer support 120 (in addition to the first contact member 222). This second point of applied force will tend to prevent the trailer support 120 from tipping over or skidding due to the moment that would result if only one point of applied force at one height was provided to the trailer support 120.

In an embodiment such as that provided in FIGS. 2 to 8, the at least one second contact member 232 of the second support structure 230 is a substantially horizontal, second circular contact beam. The second circular contact beam may have a length that is greater than the width of apparatus defined by the outer vertical edges of the vertical members 206c of the apparatus frame 206.

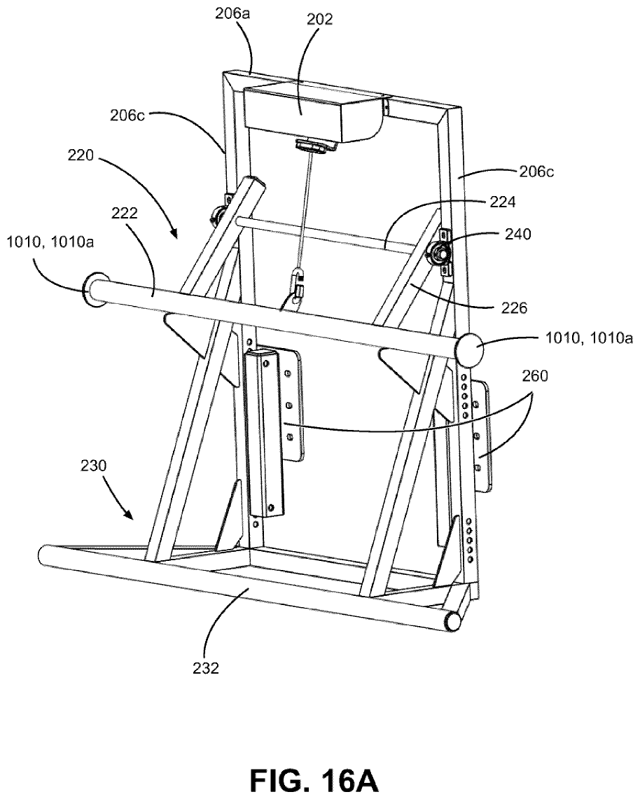

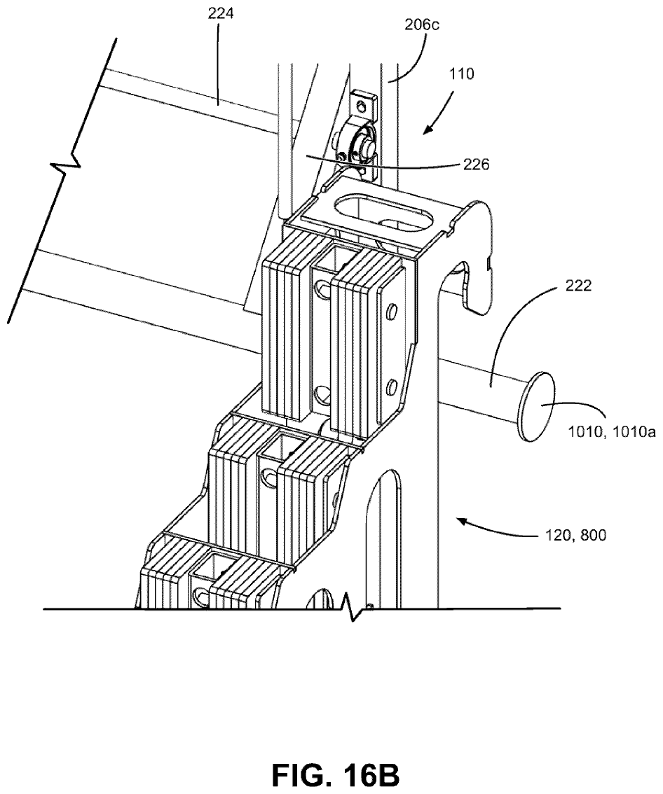

In an embodiment as shown in FIGS. 16A to 16B, at least one of the first contact member 222 and second contact member 232 of the first and second support structures 220, 230 comprise end barriers 1010. In an embodiment, the end barriers 1010 are mounted to opposing end faces of the first and/or second contact members 220, 230. The end barriers 1010 are each sized such that an outer dimension of each end barrier 1010 is greater that an outer dimension (i.e., radius) of the first and/or second contact member 222, 232. In this way, the end barriers 1010 act as limits on the first and/or second contact members 222, 232, and prevent lateral disengagement of the first and/or second contact member 222, 232 from the corresponding receiving channel 810 of the trailer support 120, 800.

In the specific embodiment provided in FIGS. 16A to 16B, the end barriers 1010 are a pair of circular end caps 1010a mounted on each end face of the first contact member 222.

Referring to FIGS. 2 and 5A to 5B, the second support structure 230 is shown to comprise a plurality of beam elements 236 that are fixedly mounted to, and that extend outward from, the apparatus frame 206. In this embodiment, the plurality of beam elements 236 are fixedly mounted to the apparatus frame 206 for supporting the second contact member 232 in the form of the second circular contact beam.

In the specific embodiments provided in FIGS. 2 and 5A to 5B, the plurality of beam elements 236 are shown to extend laterally outward, away from the apparatus frame 206. The plurality of beam elements 236 comprise a pair of horizontal beams 236a, each extending between the second circular contact beam and a joint of the bottom member 206b and one vertical member 206c of the apparatus frame 206. The plurality of beam elements 236 also comprise first and second pairs of angled support beams 236b, 236c. The first pair of angled support beams 236b extend between end portions of the second circular contact beam and the joints of the bottom member 206b and vertical members 206c of the apparatus frame 206. The second pair of angle beams 236c each extend between the second circular contact beam and one vertical member 206c of the apparatus frame 206.

The first and second pair of angled support beams 236b, 236c are provided on the second support structure 230 to inhibit twisting or bending of the second contact member 232 when the second contact member 232 contacts the trailer support 120.

While the horizontal beams 236a and angle support beams 236b, 236c are shown to be formed as angle beams in the exemplary embodiment provided herein, it will be readily understood that various beam forms and shapes can be used to form the plurality of beam elements 236 of the second support structure 230.

In an embodiment, the plurality of beam elements 236 are welded in place between the second contact member 232 and the apparatus frame 206.

In an embodiment such as that shown in FIGS. 5A and 5B, a gusset 520 is welded between each of the vertical members 206c of the apparatus frame 206 and the and horizontal beams 236a of the plurality of beam elements 236.

In an alternate embodiment of the second support structure 230, the plurality of beam elements 236 of the second support structure 230 are mounted to a spring-loaded body that is connected to the apparatus frame 206. In this embodiment, the spring-loaded body provides padding and/or damping of impacts and vibrations that can be transferred to the apparatus frame 206 when the second contact member 232 is brought into contact with the trailer support 120.

As presented previously, the apparatus 110 comprises the actuator 204 that is connected to the apparatus frame 206 and the first support structure 220 for driving the actuation of the first support structure 220. The actuator 204 generally comprises an actuating portion 204a and a driving portion 204b that is connected to the actuating portion 204a for driving an actuation of the actuating portion 204a.

In an embodiment, the actuator 204 of the apparatus 110 is mounted directly to the apparatus frame 206. The actuator 204 is positioned on the apparatus frame 206 to be operably connected to the first contact member 222 of the first support structure 220 for driving the movement of the first contact member 222 of the first support structure 220 relative to the apparatus frame 206.

In an additional embodiment, the actuator 204 comprises an actuator housing 202 that is mounted to the apparatus frame 206, where the driving portion 204b of the actuator 204 is at least partially contained within the actuator housing 202.

In the specific embodiment provided in FIG. 2, the actuator housing 202 is a box-shaped housing within an open bottom end. A rear surface of the actuator housing 202 is mounted along the top member 206a of the apparatus frame 206.

The driving portion 204b of the actuator 204 may be powered by an actuator battery, where the actuator battery is connected to the driving portion 204b of the actuator 204 and is housed within the actuator housing 202. Alternatively, the driving portion 204b of the actuator 204 is powered via a battery that is provided by the vehicle 130, where the driving portion 204b of the actuator is connected directly to the battery of the vehicle 130.

In an exemplary embodiment where the vehicle 130 is a shunt truck, the battery of the vehicle 130 is a 12V shunt truck battery.

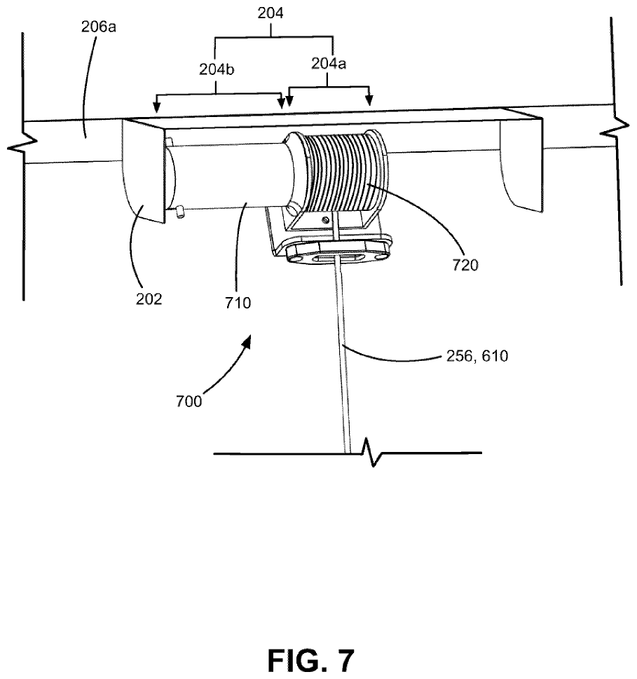

In an embodiment such as that provided in FIGS. 6 and 7, the actuator 204 comprises a winch 700. The winch 700, in this embodiment, a cable winch, comprises a length of a winch cable 610 such as a steel winch cable or a synthetic winch rope, and a load hook 620. The drive portion 204b of the actuator 204 comprises a winch drive assembly 710, and the actuating portion 204a comprises a drum assembly 720. The load hook 620 is mounted to one end of the length of cable 610, and the load hook 620 is attached through the flange 252a or similar connecting structure 252 of the first contact member 222. The load hook 620 is releasably connected to the first support structure 220 and the cable 610 is connected between the drum assembly 720 and the load hook 620. The cable 610 is at least partially wound around the drum assembly 720 and the drum assembly 720 is connected to, and driven by, the drive assembly 710 of the winch 700.

In an embodiment such as that shown in FIGS. 2, 3A to 3F and 7, the winch drive assembly 710 and drum assembly 720 are mounted within the actuator housing 202. The cable 610 extends into the actuator housing 202 and is at least partially wound around the drum assembly 720.

In the specific embodiment provided in FIG. 7, the winch drive assembly 710 comprises a drive motor. In an exemplary embodiment, the drive motor of the drive assembly 710 is a 12V, DC, series-wound motor.

As presented previously, the actuator 204 is connected to the first support structure 220 for driving an actuation of the first support structure 220 between the first, second and third positions relative to the apparatus frame 206.

In the specific embodiments provided in FIGS. 3A to 3F, the actuator 204 is the winch 700 that is connected to the first circular contact bar (the first contact member 222) of the first support structure 220. In driving the actuation of the first support structure 220 relative to the apparatus frame 206, the circular contact bar is pulled by the cable 610 of the winch 700 from the first position (shown in FIGS. 3A and 3D) through to the second position (shown in FIGS. 3B and 3E), where the beam elements 226 of the first support structure 220 are substantially perpendicular to the vertical members 206c of the apparatus frame 206. From the second position, the winch 700 can be actuated to release the first contact bar back to the first position, or the circular contact bar can be further driven by the winch 700 to the third position (shown in FIGS. 3C and 3F) where the first contact member 222 reaches an uppermost point.

Although the embodiments provided in the drawings of the present disclosure show an actuator 204 in the form of a winch 700, it will be readily understood that various other mechanisms can be utilized as the actuator 204 of the apparatus 110. In a first alternate embodiment, the actuator 204 comprises a hydraulic-based, actuator mechanism. In additional embodiments, the actuator 204 can comprise a ball screw mechanism or a jack screw mechanism that is connected between the first support structure 220 and the apparatus frame 206.

In an embodiment, the apparatus 110 comprises an actuator switch that is operably connected to the actuator 204 for starting or stopping an actuation of the actuator 204 to drive the first contact member 222 between the first, second and third positions relative to the apparatus frame 206. In an alternate embodiment, the apparatus 110 comprises an actuator control system that is operably connected to the driving portion of the actuator 204 for controlling the actuation of the actuator 204.

In an embodiment, the actuator control system comprises a first control element that is mounted within the actuator housing 202 and a second control element that is positioned on or within the vehicle 130, wherein each of the first and second control elements are operably connected via a cable connection, and wherein each of the first and second control elements comprises an integrated controller.

In an embodiment, the actuator control system is a remote-control system comprising a first control element that is mounted within the actuator housing 202 and a second control element that is positioned on or within the vehicle 130, each of the first and second control elements comprising a receiver-transmitter element and an integrated controller connected to the receiver-transmitter element.

In an additional embodiment, the vehicle 130 on which the apparatus 110 is mounted is an autonomous vehicle. The autonomous vehicle comprises an autonomous vehicle control system, and the actuator control system is an integrated actuator control system that is operably connected within the vehicle control system of the autonomous vehicle.

In an embodiment, the autonomous vehicle control system comprises a vision system. The vision system of the autonomous vehicle comprises a vision sub-system for the apparatus 110 comprising a plurality of vision system elements positioned on the autonomous vehicle and directed towards the apparatus 110 that is mounted on the autonomous vehicle to acquire image data related to the apparatus 110.

In an additional embodiment, the vision sub-system for the apparatus 110 comprises at least two vision system elements mounted on left and right sides of the front of the autonomous vehicle and aimed to capture images of the apparatus 110. By providing at least two vision systems on opposing left and right sides of the autonomous vehicle, the vision system can fully visualize the apparatus 110 and accurately determine the depth of field of various features of the apparatus 110 that are imaged by the vision subsystem.

As presented previously, the apparatus 110 as disclosed herein can be releasably coupled to a trailer support 120. The trailer support 120 generally comprises at least one top surface, at least one bottom surface, at least one rear surface and at least one front surface. The at least one top surface defines at least one trailer support portion on which a surface of a trailer will rest when the trailer support 120 is positioned beneath the trailer by the apparatus 110.

The trailer support 120 can be various forms and sizes of trailer supports. Referring to the embodiments provided in FIGS. 1, 9A to 9D, 11, 12, 13A to 13C, 14A to 14C and 15, the trailer support 120 is a shuntable trailer support 800.

Referring to the exemplary embodiments shown in FIGS. 9, 10 and 11, the shuntable trailer support 800 also comprises and defines therein at least one receiving channel 810 that is sized to receive the at least one first contact member 222 of the first support structure 220. In an additional embodiment, the at least one receiving channel 810 is positioned on the trailer support 120 such that the receiving channel 810 is open in a direction towards the bottom of the frame of the trailer support 120 and the first contact member 222 is advanced up and into the receiving channel 810 when the first contact member 222 is received in the receiving channel 810.

In the specific embodiments of the shuntable trailer support 800 provided in FIGS. 1, 9A to 9D, 11, 12, 13A to 13C, 14A to 14C and 15, the shuntable trailer support 800 comprises a plurality of hook-shaped members 820 projecting in a rearward direction from the shuntable trailer support 800. In this specific embodiment, the hooked form of each of the hook-shaped members 820 defines a channel portion therein. The hook-shaped members 820 of the trailer support 800 are relatively aligned along the trailer support 800 such that the channel portion of each of the plurality of hook-shaped members 820 can be said to collectively define the at least one receiving channel 810 of the trailer support 800.

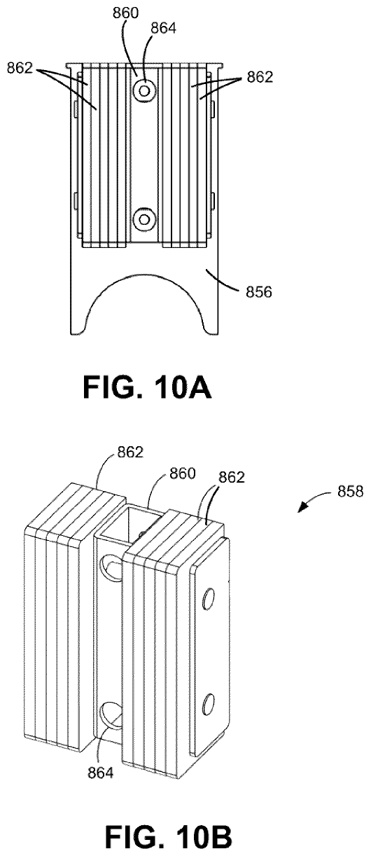

In the embodiment shown in FIGS. 9 and 10, the plurality of hook-shaped members 820 are disposed at corresponding heights about the at least one rear surface of the trailer support 800 and are transversely spaced along the at least one rear surface of the trailer support 800 to collectively define the at least one receiving channel 810 of the trailer support 800.

In one exemplary embodiment of the trailer support 120 such as the shuntable trailer support 800 provided in FIGS. 1, 9A to 9D, 11, 12, 13A to 13C, 14A to 14C and 15, the shuntable trailer support 800 is formed as a stepped trailer support 800a.

In an embodiment, the shuntable trailer support 800 comprises pairs of front and rear legs 832, 834 as well as front and rear cross supports 833, 835 extending between each pair of legs 832, 834. In the specific embodiments of FIGS. 9A to 9D, the pairs of front and rear legs 832, 834 are pairs of substantially vertical front and rear legs 832, 834. Each of the front and rear legs 823, 824 is supported on a bottom plate 838 such that each leg is normal to the bottom plate 838. The front cross support 833 is connected to a top surface of each front leg 832 and the rear cross support 835 is connected to a top surface of each rear leg 834.

In an embodiment, any of the pairs of front and rear legs 832, 834, and the front and rear cross-supports 833, 835 may be made from, but are not limited to, metal tubing, such as 6″×6″ steel tubing.

Between each of the front legs and each of the rear legs 832, 834 is a leg bracing member 842 which keeps the legs 832, 834 apart and prevents the legs 832, 834 from twisting relative to each other in the case where a ground surface on which the trailer support 800 sits is not level. The leg brace member 842 may be formed from a metal plate, such as rolled steel plate.

In an embodiment, the structure of the shuntable trailer support 800 also comprises angled support beams 844 that are mounted on, and extend between, each of the front and rear legs 832, 834 and each of the front and rear cross supports 833, 835. In a further embodiment, the angled support beams 844 are welded in place between the cross supports 833, 835 and the legs 832, 834.

In the embodiment of FIGS. 9A to 9D, the bottom plates 838 upon which one of front and rear legs 832, 834 are each mounted is itself mounted on a pair of support blocks 846 via a pair of angle brackets 845. The bottom plate 838 can be secured to the bottom of the front and rear legs 832, 834 by welding. The angle brackets 845 that secure the bottom plate 838 on the support blocks 846 can also be secured in place by fasteners 847 which are threaded into the bottom plate 838 and each of the support blocks 846. In the exemplary embodiment provided in FIGS. 9A and 9B, the fastener is a threaded bolt.

In an alternate embodiment, the angle brackets 845 that secure the bottom plates 838 on the support blocks 846 can also be welded in place on the support blocks 846 and a bottom surface of the bottom plates 838.

In the specific embodiment of FIGS. 9A, 9B and 9C, two gussets 848 are mounted in place between the bottom plate 838 and each of the front and rear legs 832, 834 to further secure the legs 832, 834 on the bottom plate 838. In a further embodiment, the gussets 848 are welded in place between the bottom plate 838 and legs 832, 834. In the specific embodiments provided in FIGS. 1, 9A to 9D, 11, 12, 13A to 13C, 14A to 14C and 15, the shuntable trailer support 800 is a stepped, shuntable trailer support 800a that comprises a plurality of stepped, top support surfaces.

Turning specifically to the embodiment of FIGS. 9A and 9B where the trailer support 120 is the stepped, shuntable trailer support 800a, the stepped, shuntable trailer support 800a comprises a pair of stepped landing assemblies 850 disposed on left and right sides of the cross supports 833, 835 of the trailer support 800a. Each stepped landing assembly 850 sits atop and is connected to the front cross support 833 of the front pair of legs 832 and the back cross support 835 of the back pair of legs 834. Each stepped landing assembly 850 comprises a stepped inner plate 852, a stepped outer plate 854, a plurality of frame members 856 extending between the stepped inner and outer plates 852, 854, and a plurality of bumpers 858.

The stepped inner and outer plates 852, 854 of each stepped landing assembly 850 are mounted in an upright orientation and are sized to traverse the gap between the front and rear cross supports 833, 835, and to extend beyond the front and rear pairs of legs 832, 834. The plurality of frame members 856 of each stepped assembly 850 extend between and are connected between the stepped inner and outer plates 852, 854 to support the inner and outer plates 852, 854 in their upright orientations. The stepped inner plate and stepped outer plate 852, 854 act much like stringers in stair construction, where each plate 852, 854 comprises treads and risers to form stages or steps. As shown in FIGS. 9A and 9B, the treads and risers of the stepped inner plate 852 substantially align with the treads and risers of the stepped outer plate 854 to form open steps of the stepped landing assembly 850.

Referring to FIGS. 9A, 9B, 10A and 10B, the plurality of bumpers 858 are disposed within the open steps within each stepped landing assembly 850. As shown in FIG. 9A, one of the frame members 856 is provided for each bumper 858 in each step of the landing assembly 850, and each of the bumpers 858 is mounted to the corresponding frame member 856. Each of the bumpers 858 are mounted to the corresponding frame member 856 such that a top surface of the bumper 858 is substantially co-planar to a corresponding tread of each of the stepped inner and outer plates 852, 854. In this way, the bumpers 858 provide a landing platform for each of the treads defined by the stepped inner and outer plates 852, 854.

The bumper 858 prevents metal-on-metal contact between the risers of the stepped inner and outer plates 852, 854 and a bottom surface of a trailer that is to be supported on the trailer support 800a. The bumper 858 is shown in more detail in FIGS. 10A and 10B and has a substantially rectangular shape. In this exemplary embodiment, the bumper 858 can be made to a sufficient size and shape to absorb the contact from a semi-trailer. The bumper 858 comprises a central, rectangular bar 860 and a plurality of partially elastic plates 862 mounted to opposing sides of the rectangular bar 860. The sides of the rectangular bar 860 on which the partially elastic plates are not mounted comprises at least one borehole 864 which is provided for mounting the bumper 858 to its corresponding frame member 856. In a further embodiment, the partially elastic plates 862 of the bumper 858 are made from molded rubber or plastic.

In an embodiment, the pair of stepped landing assemblies define the at least one receiving channel 810 for the first contact member 222 of the apparatus 110. In this embodiment, the plurality of hook shaped members 820 of the trailer support 120 are a plurality of hooks 880 that are formed as a part of the stepped landing assemblies 850. The plurality of hooks 880 extend from the trailer support 120 to define a receiving channel 810 that is sized to receive the first contact member 222 of the first support structure 220.

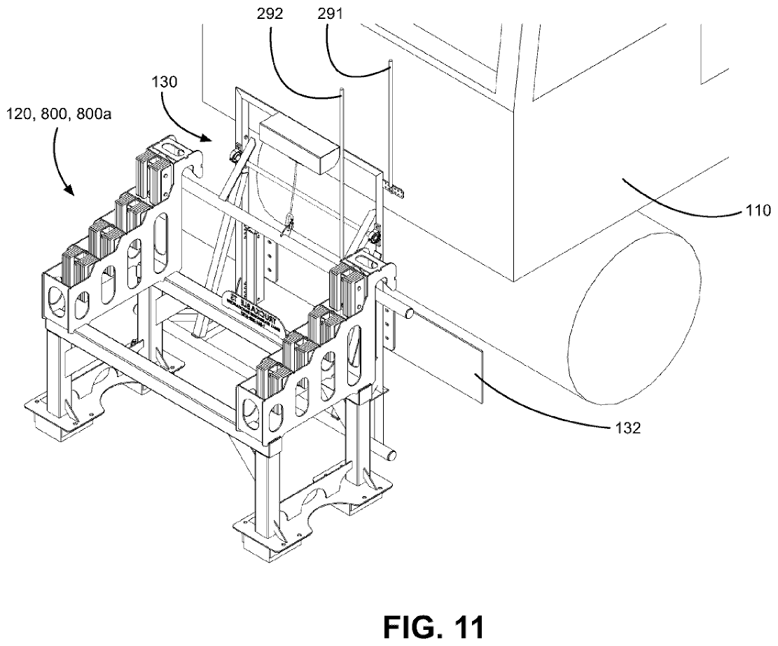

In the specific embodiment provided in FIGS. 11, 12, 13A to 13C, 14A to 14C and 15, the plurality of hooks 880 are formed as part of the stepped inner and outer plates 852, 854 and extend out from a top, rearward portion of each inner face plate and outer face plate 852, 854. The hooks 880 of each of the inner and outer face plates 852, 854 have corresponding shapes and forms.

Referring to FIG. 10A, an embodiment of one of the inner and outer face plates 852, 854 is provided. As shown in FIG. 10A, the hook 880 that is formed as part of each inner and outer face plate 852, 854 projects in a rearward direction from the plate 852, 854. The hooks 880 project from the plate in a substantially horizontal orientation and the hook 880 defines an upside-down u-shaped channel 890. As shown in FIG. 9C, the hook 880 can comprise an angled tip portion 882 that is angled inwards, towards the u-shaped channel 890. The angled tip portion 882 of the hook 880 can facilitate receiving of the first contact member 222 in the u-shaped channel 890 by guiding the first contact member 222 towards the u-shaped channel 890 as the first contact member 222 is driven to move relative to hook 880.

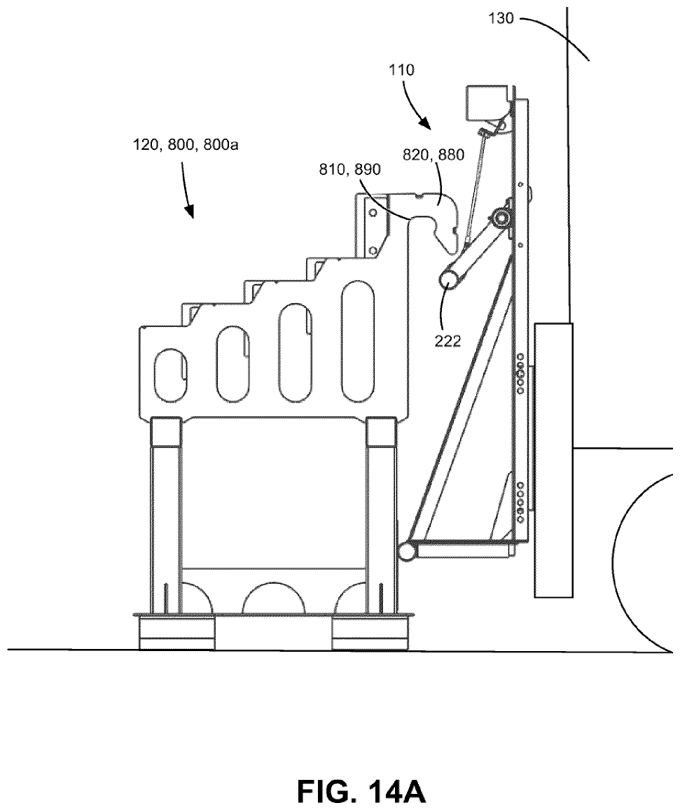

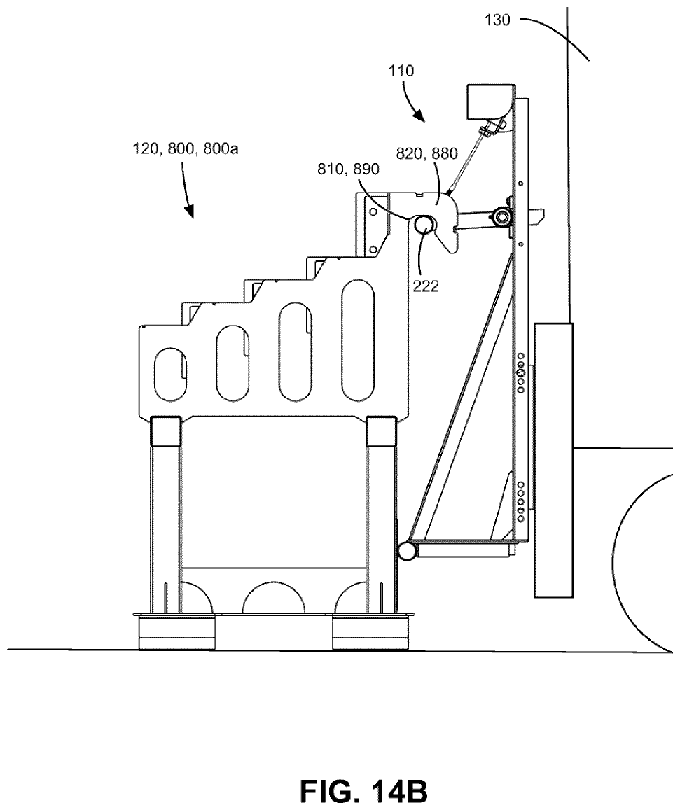

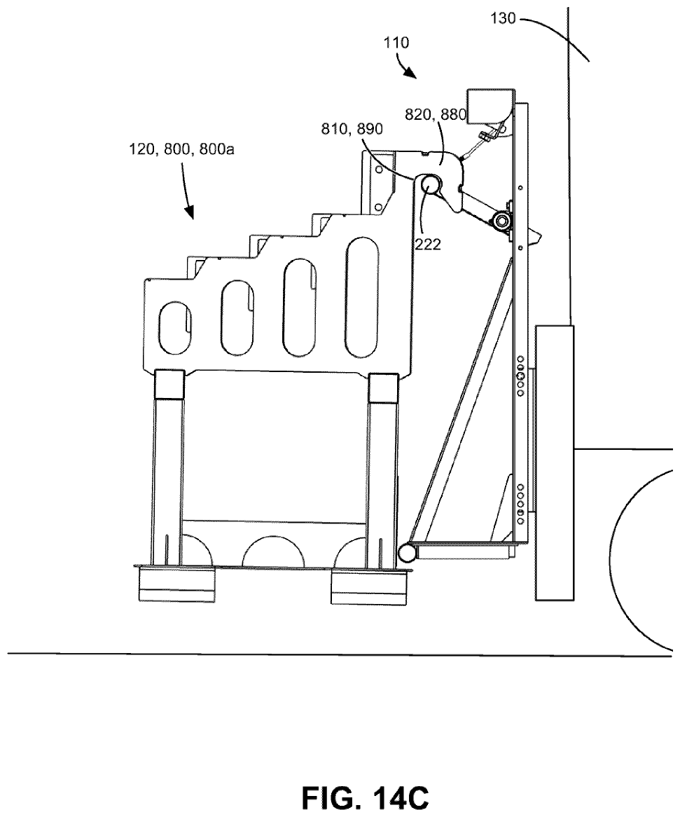

Referring to FIGS. 14A to 14C, an embodiment is provided where the u-shaped channel 890 of the hook 880 comprises an at least partially concave sidewall portion 890a. The at least partially concave sidewall portion 890a is formed in the u-shaped channel 890 to receive a portion of the first contact member 222 when the first contact member 222 has an at least partially circular form. The sidewall portion 890a securely holds the portion of the first contact member 222 as the first support structure 220 (and first contact member) is moved relative to the trailer support 800a. The concave sidewall portion 890a provides a more secure coupling of the trailer support 800a and the apparatus 110 by more securely holding the first contact member 222 (compared to a flat-walled, u-shaped channel 890).

The combined functioning of the vehicle 130 and apparatus 110 in releasably coupling, manipulating and/or maneuvering, such as moving and/or lifting the trailer support 120, will now be described. As shown in FIG. 1, the apparatus 110 mounted to the vehicle 130 can be moved into the vicinity of the trailer support 120 to releasably couple the apparatus 110 to the trailer support 120. By releasably coupling the apparatus 110 to the trailer support 120, the trailer support 120 can be moved along a surface on which the trailer support 120 rests, such as by pushing and/or pulling by the vehicle 130 via the apparatus 110 and/or lifted above and moved along the surface.

As presented previously, the actuator 204 is connected to the first support structure 220 for driving an actuation of the first support structure 220 between the first, second and third positions relative to the apparatus frame 206. In an embodiment, the apparatus 110 is mounted to the vehicle 130 (as shown in FIG. 1). If the first support structure 220 is not already in the first position relative to the apparatus frame 206, the actuator 204 of the apparatus 110 is actuated such that the first support structure 220 is in the first position relative to the apparatus frame 206. If the first support structure 220 is already in the first position relative to the apparatus frame 206, then no actuation is needed prior to driving the vehicle 130 towards the trailer support 120. The vehicle 130 is driven towards a rear side of the trailer support 120 such that the rear side is substantially parallel to the mounting surface of the vehicle 130 (e.g., the front vehicle bumper 132). The vehicle 130 advances the apparatus 110 towards the trailer support 120 until the second contact member 232 contacts the trailer support 120 and the first contact member 222 is positioned as shown in FIGS. 13A and 14A. Additional details regarding the method of aligning the vehicle 130, apparatus 110 and trailer support 120 are provided below.

With the first contact member 222 positioned as shown in FIGS. 13A and 14A, the actuator 204 (e.g., the winch 700) that is connected to the first contact member 222 of the first support structure 220 drives an actuation of the first contact member 222 to the second position shown in FIGS. 13B and 14B. In this position, the first contact member 222 in the form of the first circular contact beam is received in the channel 810 defined by the hook-shaped members 820 of the trailer support 120, 800. The applicant notes that in this position, the first circular contact beam is received in the channel 810 but is not applying a substantial lifting force on the hook-shaped members 820 of the trailer support 120, 800.

In the second position as shown in FIGS. 13B and 14B, the trailer support 120, 800 is coupled to the apparatus 110 such that when the vehicle 130 moves the apparatus 110 around on the support surface, the first circular contact beam will contact the side walls of the channel 810 of the trailer support 120, 800 and the second circular contact beam will contact the rear legs 834 of the trailer support 120, 800 to slide the trailer support 120, 800 along the ground surface.

For lifting the trailer support 120 from the ground surface, the actuator 204 drives an actuation of the first support structure 220 from the second position shown in FIGS. 13B and 14B to the third position shown in FIGS. 13C and 14C. As the first support structure 220 is actuated from the second position to the third position by the actuator 204, the first contact member 222 is drawn upwards, contacting the channel 810 of the trailer support 120, 800 and applying an at least partially upwards force to at least some of the inner surfaces of the channel 810. In this way, the trailer support 120, 800 is lifted from the ground surface by the first contact member 222.

In an embodiment, as the trailer support 120 is lifted from the ground surface, it is coupled to the apparatus 110 such that relative movement of the trailer support 120 and apparatus 110 is limited. The first contact member 222 is securely received within the channel 810 defined by the hook-shaped members 820, and the second contact member 232 will contact the rear legs 834 and/or the bottom plate 838 of the trailer support 120 to limit any pivoting of the trailer support 120 relative to the apparatus 110.

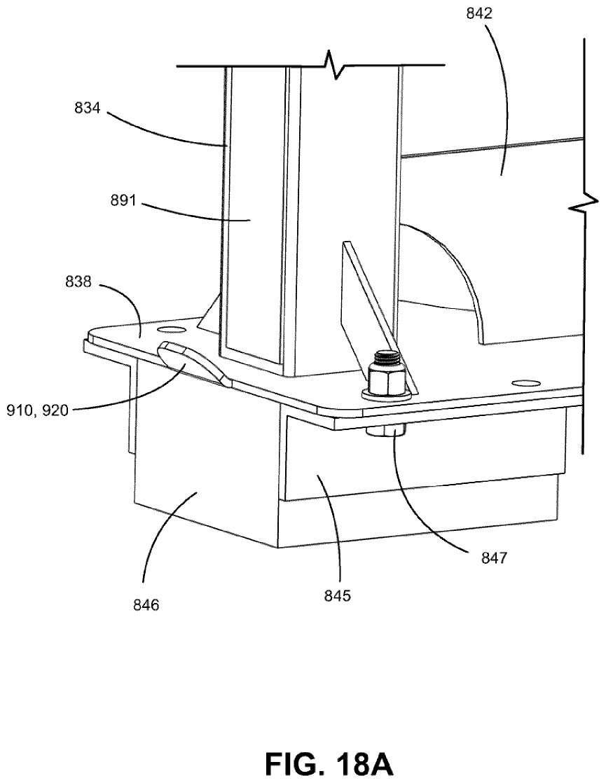

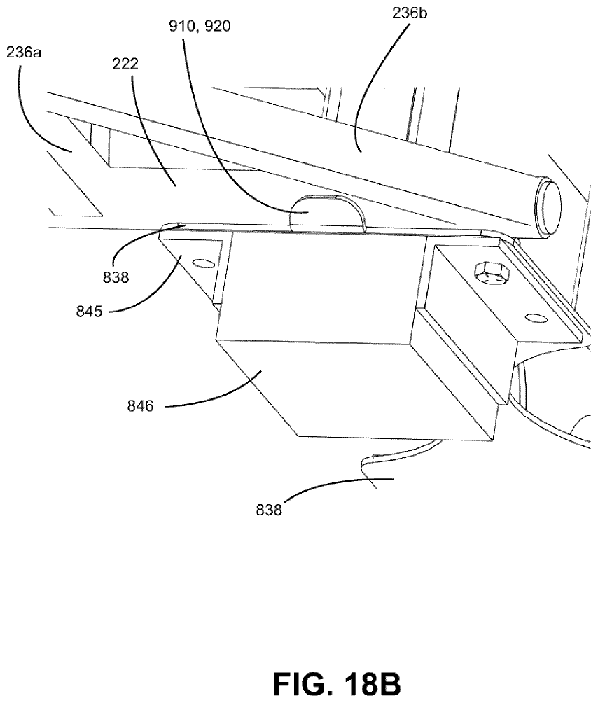

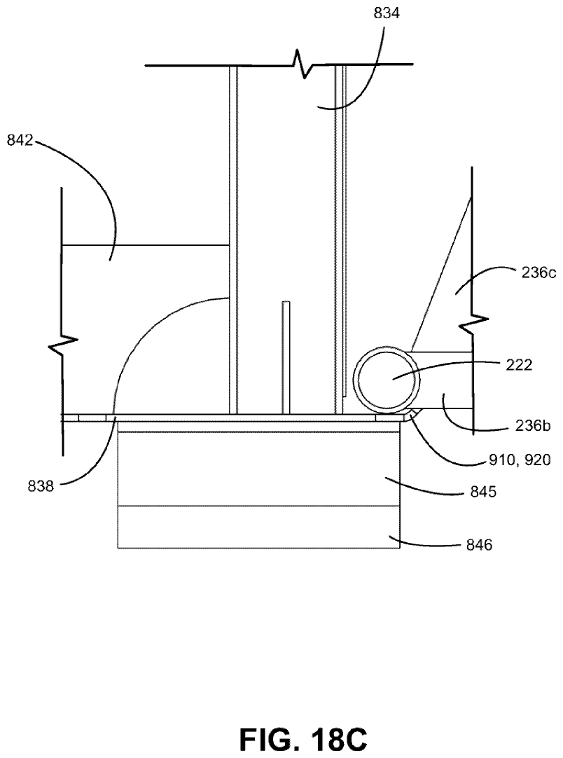

In an embodiment such as provided in FIGS. 18A to 18C, the trailer support 120, 800 comprises a securing tab 910 that is mounted to a lower portion of the trailer support 120, 800. The securing tab 910 projects our form the lower portion of the trailer support 120, 800 and the shape of the securing tab defines a receiving channel therewithin. The receiving channel is shaped such that when the first contact member 222 is releasably received by the trailer support 120, 800, and when the first support structure 220 moves to the third position relative to the apparatus frame 206 to lift the trailer support 120, 800 off the ground, the second contact member 232 contacts the securing tab 910. The securing tab 910 is shaped to releasably engage with the second contact member 232 of the second support structure in order to limit relative movement of the apparatus 110 and trailer support 120, 800 once the trailer support 120, 800 has been lifted from the ground surface by the first support structure 220 of the apparatus 110. In an embodiment, the form of the securing tab 910 prevents pivoting of the trailer support 120, 800 relative to apparatus frame 206, about the first contact member 222. By preventing this pivoting of the trailer support 120, 800, the securing tab 910 limits the possibility of the trailer support 120, 800 disengaging from the apparatus 110.

The securing tab 910 provides the additional embodiment of providing a more positive engagement between the trailer support 120, 800 and the apparatus 110, such that when the trailer support 120, 800 is being maneuvered by maneuvering the vehicle 130 bouncing or vibration that is experienced by the vehicle 130 while going over speed bumps, pot holes or the like will not cause unwanted vibration or bouncing of the trailer support 120, 800 relative to the apparatus 110.

In the specific embodiment provided in FIGS. 18A to 18C, the securing tab 910 is a pair of securing hooks 912, where one of the pair of securing hooks 912 is mounted on, and projects out from, the bottom plate 838 of each of the rear legs 834. The securing hook 912 has a form with a gradual, upward curve. In an embodiment where the second contact member 232 is the circular contact beam, the shape of the curve in the securing hook 912 substantially matches the shape of an exterior curved surface of the second circular contact beam. In this way, when the first contact member 222 is releasably received by the trailer support 120, 800, and when the first support structure 220 moves to the third position relative to the apparatus frame 206 to lift the trailer support 120, 800 off the ground, each securing hook 912 hooks under the second circular contact bar (See FIG. 18B) to releasably engage the circular contact bar as the trailer support 120, 800 is lifted off, and supported above, the ground surface.

In an embodiment such as provided in FIG. 9D, at least one rear, vertical surface of the rear legs 834 of the trailer support 120, 800 comprises a low-friction material 891, such as, for example, but not limited to, a sheet of low-friction plastic, mounted thereon. The low-friction material 891 functions to reduce friction between the second contact member 232 and the rear legs 834 of the trailer support 120 as the second contact member 232 is slid up along the rear legs 834 (this sliding may occur while the first support structure 220 moves from the second to the third position to lift the trailer support 120).

In an embodiment provided herein, the above-presented interfacing of the apparatus 110 and trailer support 120 for moving and lifting the trailer support 120 will now be described with reference to the movement of the vehicle 130. The specific embodiment as provided here comprises distance references for the spacing of the operating vehicle 130, trailer support 120 and apparatus 110. It will be readily understood that these distances are merely drawn to one exemplary sizing of one exemplary apparatus 110 and trailer support 120 and are not meant to limit the method of use of this apparatus to one particular arrangement.

In an embodiment of a method for using the apparatus 110 and vehicle 130 to manipulate the trailer support 120 under a nose of a trailer is provided. In this embodiment, the vehicle 130 and apparatus 110 are maneuvered along a ground surface, towards the trailer support 120 supported on the ground surface, until the second contact member 232 of the apparatus 110 contacts the trailer support 120 on the side of the trailer support 120 that comprises the receiving channel.

In an embodiment, the vehicle 130 is maneuvered such that when the second contact member 232 contacts the trailer support 120, a centerline of the trailer support 120 is substantially aligned with a centerline of the apparatus 110.

From this position, the actuator 204 of the apparatus 110 is actuated to drive a movement of the first support structure 220 from the first position to the second position to releasably couple the trailer support 120 and apparatus 110. The actuator 204 of the apparatus 110 is then actuated to drive a movement of the first support structure 220 from the second position to the third position to lift the trailer support 120 off the ground surface.

In an embodiment, the apparatus 110 lifts the trailer support 120 to a height such that a bottom surface of the trailer support 120 is, for example, at least 6″ of the ground surface.

After lifting the trailer support 120 from the ground surface, the apparatus 110 and vehicle 130 are maneuvered towards the nose of the trailer. The apparatus 110 and vehicle 130 are maneuvered such that the trailer support 120 is substantially collinear with the trailer. The actuator 204 is actuated to drive the first support structure 220 from the third position to the second position to set the trailer support 120 down on the ground surface at a predetermined distance from the nose of the trailer. Once the trailer support 120 is set on the ground surface, the actuator 204 is actuated from the second position to the first position to release the first contact member 222 from the trailer support 120. The apparatus 110 and vehicle 130 are then maneuvered forward such that the trailer support 120 is shunted under the nose of a trailer (the second contact member 232 is pushing the trailer support 120) until the trailer support 120 is securely positioned under the nose of the trailer.

In a further embodiment, a similar method is provided for removing the trailer support 120 from under the nose of the trailer. In this embodiment, the vehicle 130 and apparatus 110 are maneuvered towards and up to the trailer support 120 while the trailer support 120 is under the trailer. When the second contact member 232 contacts the trailer support 120, the movement of the vehicle 130 is stopped. The actuator 204 is then actuated to drive a movement of the first support structure 220 towards the third position such that the first contact member 222 becomes releasably coupled to the trailer support 120, and such that the first contact member 222 is exerting a slight upward pressure on the receiving channel 810 of the trailer support 120. In this embodiment, the weight of the nose of the trailer prevents a full movement of the first support structure 220 to the third position. Once the apparatus 110 and trailer support 120 are releasably coupled, the vehicle 130 is maneuvered backwards to slide the trailer support 120 out from under the nose of the trailer. From this point, the actuator 204 can be actuated to drive the first support structure 220 fully to the third position, such that the trailer support 120 is lifted off the ground surface. The vehicle 130 can then be maneuvered to transport the lifted trailer support 120 towards another destination.

As noted above, an embodiment of the apparatus 110 and trailer support 120 comprises the alignment body 291 positioned on the apparatus 110 and the alignment body 292 positioned on the trailer support 120. The alignment bodies 291, 292 are provided as guides to facilitate correct alignment of the apparatus 110 and trailer support 120 when the vehicle 130 is maneuvered to releasably couple the apparatus 110 and trailer support 120.

In an embodiment such as that provided in FIGS. 13A to 13C, and 15, the alignments bodies 291, 292 are first and second vertical poles, respectively. The first vertical pole is mounted to the apparatus frame 206, for example, either directly or indirectly via, for example, a pole support plate, and the second vertical pole is mounted to one of the stepped landing assemblies 250, for example, either directly or indirectly, via, for example, a pole support plate.

### Alternate Embodiment of the Trailer Support

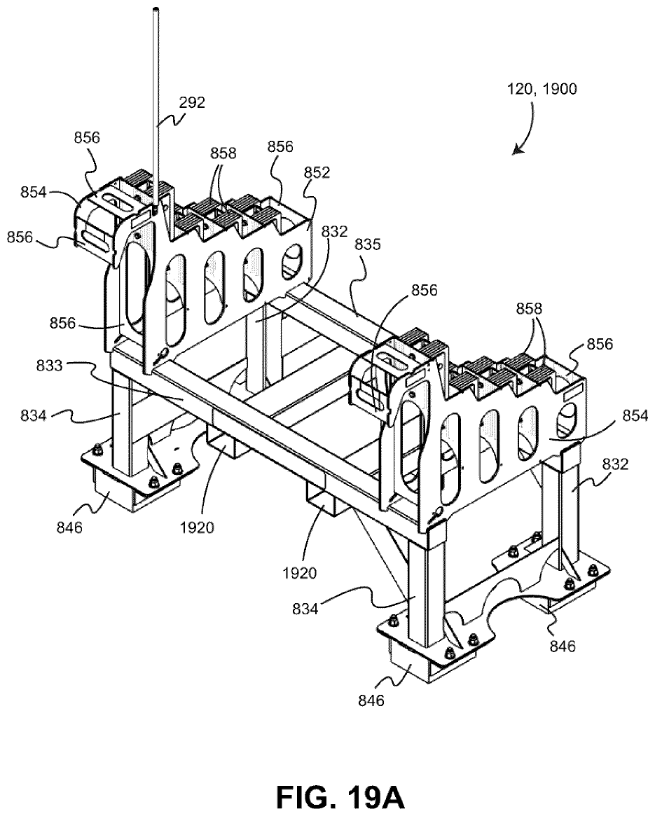

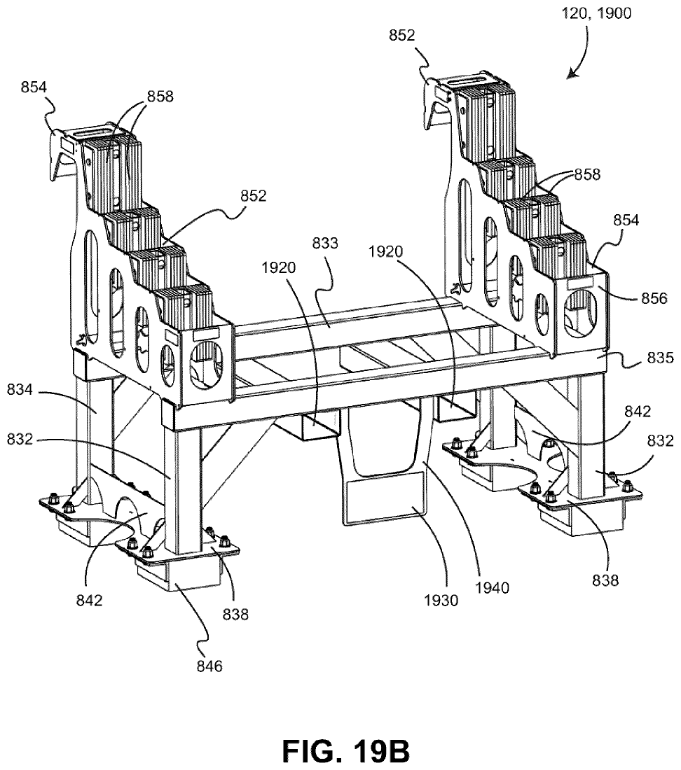

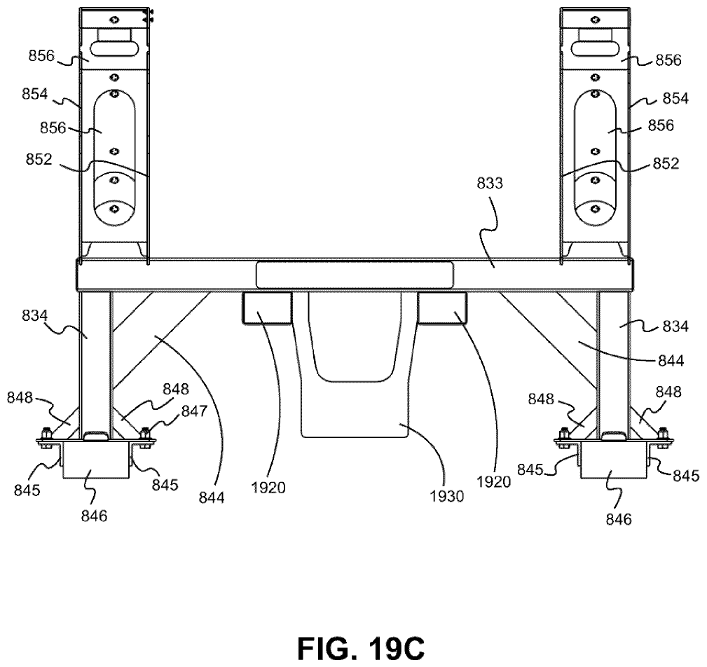

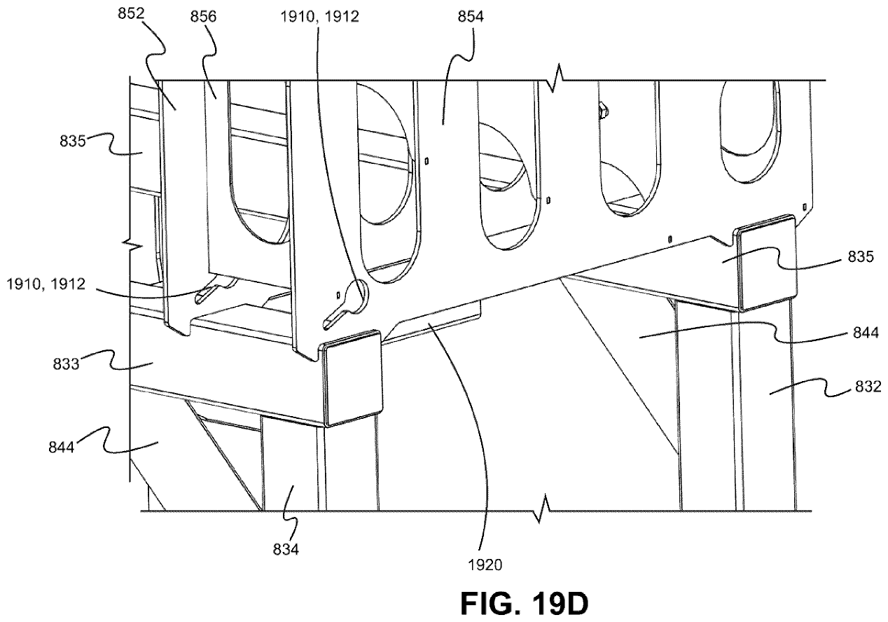

Referring to FIGS. 19A to 27D, an alternate embodiment of the trailer support 120 and apparatus 110 is provided.

Referring to FIGS. 19A to 19D, an alternate embodiment of the trailer support 120 is provided, where the trailer support 120 is configured as a repositionable trailer support 1900. Like the shuntable trailer support 800, the repositionable trailer support 1900 comprises the at least one receiving channel 810 that is shaped and/or sized to receive the at least one first contact member 222 of the first support structure 220.

The repositionable trailer support 1900 comprises the plurality of hook-shaped members 820 projecting in a rearward direction from the repositionable trailer support 1900. The plurality of hook-shaped members 820 are disposed at corresponding heights about the at least one rear surface of the repositionable trailer support 1900 and are transversely spaced along the at least one rear surface of the repositionable trailer support 1900 to collectively define the at least one receiving channel 810 of the repositionable trailer support 1900.

Like the shuntable trailer support 800, the repositionable trailer support 1900 comprises the pairs of front and rear legs 832, 834 as well as front and rear cross supports 833, 835 extending between each pair of legs 832, 834, where each pair of legs 832, 834 is supported on the bottom plate 838, and the bracing members 842 are provided between each of the front and rear legs 832, 834 to prevent relative twisting of the front and rear legs 832, 834. The bottom plates 838 of the repositionable trailer support 1900 are each mounted on the pair of support blocks 846 via the pair of angle brackets 845. The repositionable trailer support 1900 also comprises the angled support beams 844 that are mounted on, and extend between, each of the front and rear legs 832, 834, and the two gussets 848 positioned between the bottom plates 838 and the front and rear legs 832, 834.

In the specific embodiments of the shuntable trailer support 800 provided in FIGS. 19A to 19D, the repositionable trailer support 1900 is formed as a stepped trailer support.

In the same embodiments shown in FIGS. 19A to 19D where the repositionable trailer support 1900 is a stepped, repositionable trailer support, the repositionable trailer support 1900 comprises the pair of stepped landing assemblies 850 structured substantially similarly to the landing assemblies of the stepped, shuntable trailer support 800a. Each stepped landing assembly 850 sits atop and is connected to the front cross support 833 of the front pair of legs 832 and the back cross support 835 of the back pair of legs 834. Each stepped landing assembly 850 comprises the stepped inner plate 852, the stepped outer plate 854, the plurality of frame members 856 extending between the stepped inner and outer plates 852, 854, and the plurality of bumpers 858. As shown in FIGS. 19A to 19D, the plurality of hook shaped members 820 are formed as a part of the stepped landing assemblies 850. Each of the plurality of hook-shaped members 820 are formed as part of the stepped inner and outer plates 852, 854 and extend out from the top, rearward portion of each inner face plate and outer face plate 852, 854.

Referring still to FIGS. 19A to 19D, the repositionable trailer support 1900 is formed to be lifted and/or repositioned by a lifting assembly 110 and is structured to be connected to the lifting assembly 110 by various means. As provided above, the repositionable trailer support 1900 is structured to be connected to the lifting assembly 110 by the first contact member 222 that is releasably received in the at least one receiving channel 810. The repositionable trailer support 1900 comprises the at least one receiving channel 810 that is defined by the plurality of hook-shaped members 820, where the at least one receiving channel 810 is sized to receive the first contact member 222 from the apparatus 110.

In an additional embodiment, the repositionable trailer support 1900 also comprises a secondary receiving channel 1910 that extends laterally through the repositionable trailer support 1900 and is sized to receive a connecting member therethrough. When the connecting member is received through the secondary receiving channel 1910, the repositionable trailer support 1900 can be dragged along a ground surface to facilitate repositioning of the repositionable trailer support 1900.

In an embodiment, the connecting member is a length of chain or similar cable material that is attached to the vehicle 130 and is looped through the secondary receiving channel 1910 for dragging the repositionable trailer support 1900 along the ground surface. The secondary receiving channel 1910 is sized such that one end of the length of chain can be fed through one end and out another end of the secondary receiving channel such that the length of chain is looped through the secondary receiving channel to secure the repositionable trailer support 1900 to the vehicle 130.

In the specific embodiment provided in FIGS. 19A to 19D, the secondary receiving channel 1910 is defined by a pair of keyholes 1912, where one of the pair of keyholes 1912 is formed in each of the stepped outer plates 854, and the stepped inner plates 852 towards rear, bottom corners of the stepped outer plate 854 and stepped inner plate 852. In this way, the secondary receiving channel 1910 is defined between the pair of stepped outer plates 854 and the pair of stepped inner plates 852 and extends laterally along the repositionable trailer support 1900. Each of the pair of keyholes 1912 is formed as an aperture with a first, circular portion and a second, narrow portion extending off the first, circular portion.

Referring still to the embodiment such as shown in FIGS. 19A to 19D, the repositionable trailer support 1900 also comprises a pair of receiving tubes 1920 that are positioned along the repositionable trailer support 1900 to extend between the front and rear of the repositionable trailer support 1900, and that each define a receiving slot for a fork of a forklift. Each of the pair of receiving tubes 1920 is mounted to the repositionable trailer support 1900 and is sized and spaced apart from the other of the pair of receiving tubes 1920 such that a pair of forks of a forklift can be advanced towards and inserted into the pair of receiving tubes 1920 such that the pair of forks are removably retained in the pair of receiving tubes 1920. In this way, the pair of forks of the forklift can be raised and lowered, and the repositionable trailer support 1900 can be lifted and lowered via the forklift.

In the specific embodiments provided in FIGS. 19A to 19D, the pair of receiving tubes 1920 are a pair of rectangular metal tubes. The pair of rectangular metal tubes are mounted to an underside of each of the front cross support 833 and rear cross support 835 and are sized to extend from at least a rearmost surface of the rear cross support 835 to a frontmost surface of the front cross support 833. The pair of rectangular metal tubes can be secured to the underside of the front and rear cross supports 833, 835 by various known means, such as by welding or metal fasteners.

In an embodiment such as shown in FIGS. 19B and 19C, the repositionable trailer support 1900 comprises a reflective element 1930 that is mounted on a vertical, front face of the repositionable trailer support 1900.

In an additional embodiment, the reflective element 1930 is formed as part of a remote laser detection system for detecting the presence of a trailer support underneath a trailer at a distance away from the trailer support 120. The reflective element 1930 is composed such that laser light from the remote laser detection system will reflect thereof in a controlled manner such that the reflected laser light can be detected and analyzed by the remote laser detection system.

In the specific embodiment provided in FIGS. 19B and 19C, the repositionable trailer support 1900 comprises a mounting plate 1940 that is connected to the front cross support 833 of the repositionable trailer support 1900. The mounting plate 1940 comprises a pair of plate arms that are mounted to the front cross support 833 (via welding, fasteners, or other known means), as well as a rectangular face upon which the reflective element 1930 is mounted. The reflective element 1930 is formed as a reflective sticker that is adhered to the rectangular face of the mounting plate 1940.

### Alternate Embodiment of Apparatus for Manipulating And/or Maneuvering the Trailer Support

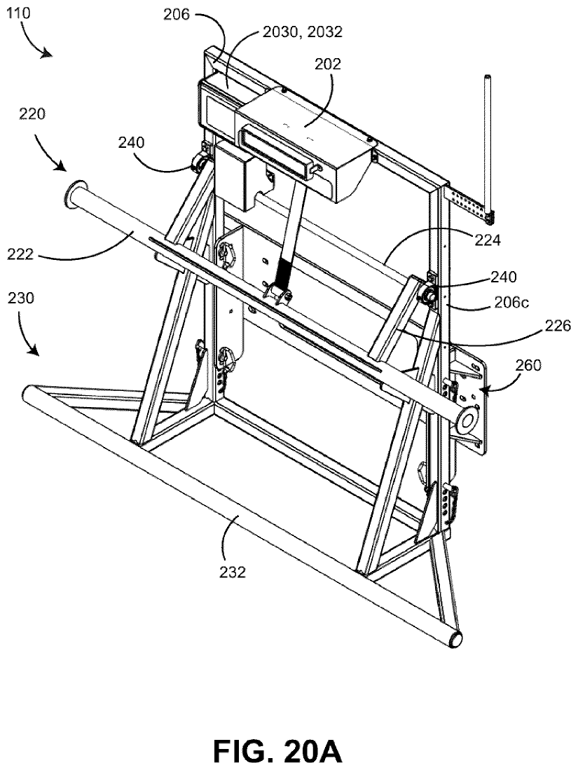

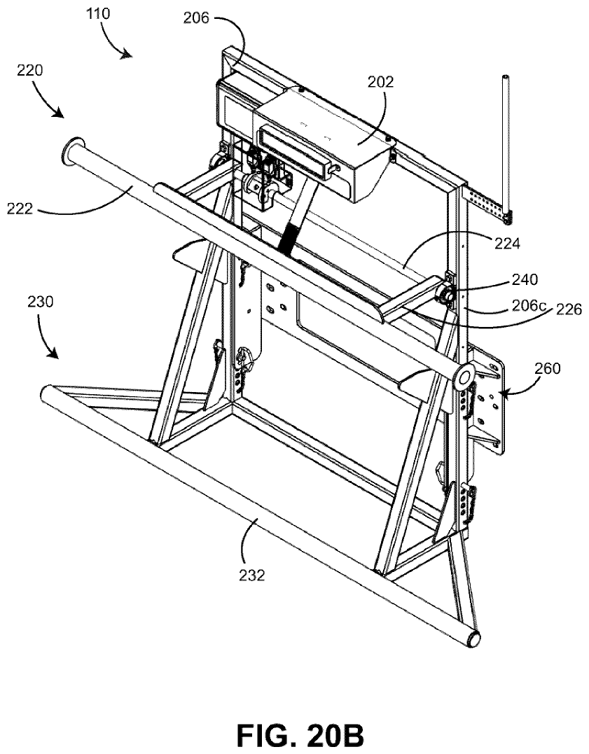

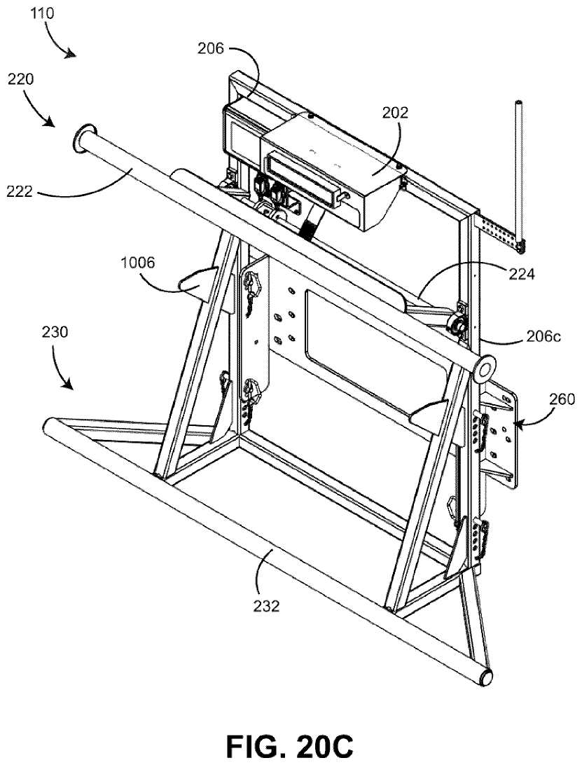

Referring to FIGS. 20A to 27D, an alternate embodiment of the apparatus 110 is provided. In this alternate embodiment of the apparatus 110, the apparatus 110 still comprises the apparatus frame 206, the first support structure 220, the second support structure 230 and the actuator 204. The first support structure 220 comprises the at least one first contact member 222 that is shaped such that when the apparatus 110 is positioned near to the trailer support 120 (either the shuntable trailer support 800 or the repositionable trailer support 1900) and when the first support structure 220 is moved from the first position shown in FIG. 20A (i.e., the rest, disengaged or uncoupled position) to the second position shown in FIG. 20B (i.e., the releasably engaged or releasably coupled position), the at least one first contact member 222 is releasably received by the at least one receiving channel 810 of the trailer support 120 for releasably coupling the trailer support 120 to the apparatus frame 206.

The second support structure 230 is mounted to the apparatus frame 206 and comprises the at least one second contact member 232 that is shaped to contact the trailer support 120. Contact of the at least one second contact member 232 with the trailer support 120 indicates to the operator that the at least one first contact member 222 is properly aligned with the trailer support 120 such that the trailer support 120 can be releasably coupled to the apparatus frame 206.

As with the first embodiment of the apparatus 110, in this alternate embodiment of the apparatus 110, the apparatus frame 206 comprises the substantially horizontal top member 206a, substantially horizontal bottom member 206b, and a pair of vertical members 206c.

In the specific embodiment provided in FIGS. 20A to 21 and 23A to 27D, each member of the apparatus frame 206 is composed from tubular metal such as steel tubing. In an exemplary embodiment, the steel tubing is 2″×2″ lengths of steel tubing that are welded or similarly joined together. It will be readily understood that various sizes, shapes and dimensions of tubing may be used to form the members 206a, 206b, and 206c of the apparatus frame 206 shown in FIGS. 20A to 21 and 23A to 27D.

In an embodiment, each vertical member 206c of the pair of vertical members 206c comprises the plurality of connecting apertures 265 for securing the mounting assembly 260 to the apparatus frame 206.

In an additional embodiment, the plurality of connecting apertures 265 on each of the pair of vertical members 206c comprises two subsets of connecting apertures 265: a set of lower connecting apertures 265a and a set of upper connecting apertures 265b that are spaced apart from and above the set of lower connecting apertures 265a. The apertures in the set of lower connecting apertures 265a and set of upper connecting apertures 265b are each configured to receive a securing element 2020 therethrough for securing the mounting assembly 260 to the apparatus frame 206 at the locations of the set of lower connecting apertures 265a and the set of upper connecting apertures 265b of each of the pair of vertical members 206c.

In an embodiment, the apertures of each of the set of upper connecting apertures 265b and the set of lower connecting apertures 265a are shaped with uniform sizes. The spacing between each aperture of the set of lower connecting apertures 265a and each aperture of the set of upper connecting apertures 265b is also uniform.

In an alternate embodiment, at least some of the apertures of the set of upper connecting apertures 265b and at least some of the apertures of the set of lower connecting apertures 265a have differing sizes, and the spacing between the apertures of the set of upper connecting apertures 265b and the apertures of the set of lower connecting apertures 265a is not the same and/or is not consistent between each apertures of each set. In one such embodiment, the upper connecting apertures 265b are spaced more closely together than the set of lower connecting apertures 265a such that the set of upper connecting apertures 265b define minor adjustment apertures and the set of lower connecting apertures 265a define major adjustment apertures. The two sets of connecting apertures on each of the pair of vertical members 206c provide varying degrees of adjustment for the position of the apparatus frame 206 of the apparatus on the vehicle 130.

As provided above, some embodiments of the apparatus 110 comprises at least one limiting device 1020 that is connected on the apparatus 110 and that is positioned to limit the movement of the first support structure 220 in at least one direction relative to the apparatus frame 206.

In an additional embodiment of the at least one limiting device 1020 shown in 20A to 21 and 23A to 27D, the at least one limiting device 1020 comprises a limiting device assembly 2010. The limiting device assembly 2010 comprises a pair of limit switches 2410, a pair of cams 2420 mounted to the first support structure 220, and a limit assembly housing 2430 in which the pair of limit switches 2410 are mounted. The limit assembly housing 2430 is mounted to the apparatus frame 206 and is positioned on the apparatus frame 206 such that the pair of cams 2420 mounted on the first support structure 220 will engage the pair of limit switches 2410 in at least some positions of the first support structure 220 relative to the apparatus frame. The pair of limit switches 2410 are operably connected to the control system 2030 of the apparatus 120 and will relay positional information about the first support structure 220 to the control system 2030.

Each cam 2420 of the pair of cams 2420 is mounted to the first support structure 220 and will move as the first support structure 220 moves relative to the apparatus frame 206 to engage one of the pair of limit switches 2410. In this way, each limit switch of the pair of limit switches 2410 corresponds to one cam of the pair of cams 2420.

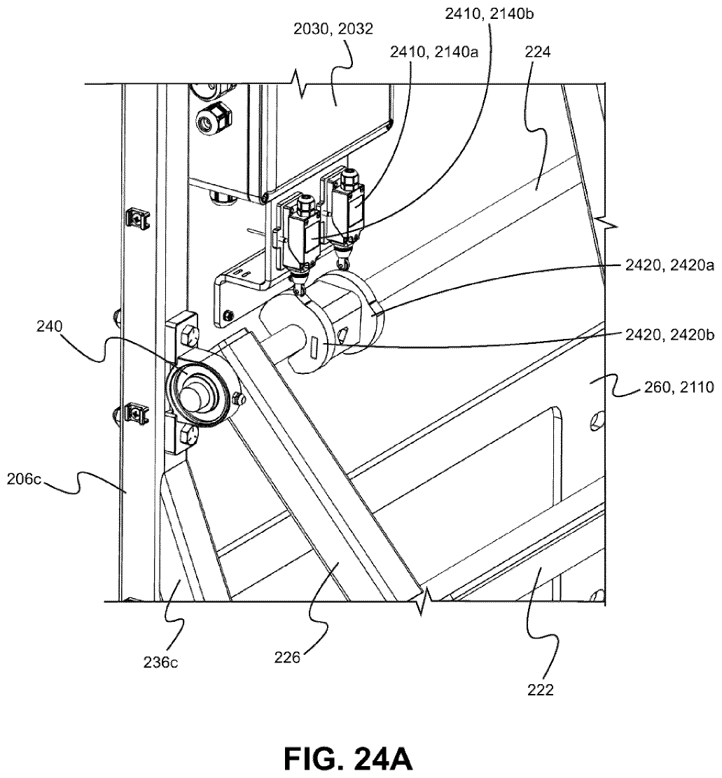

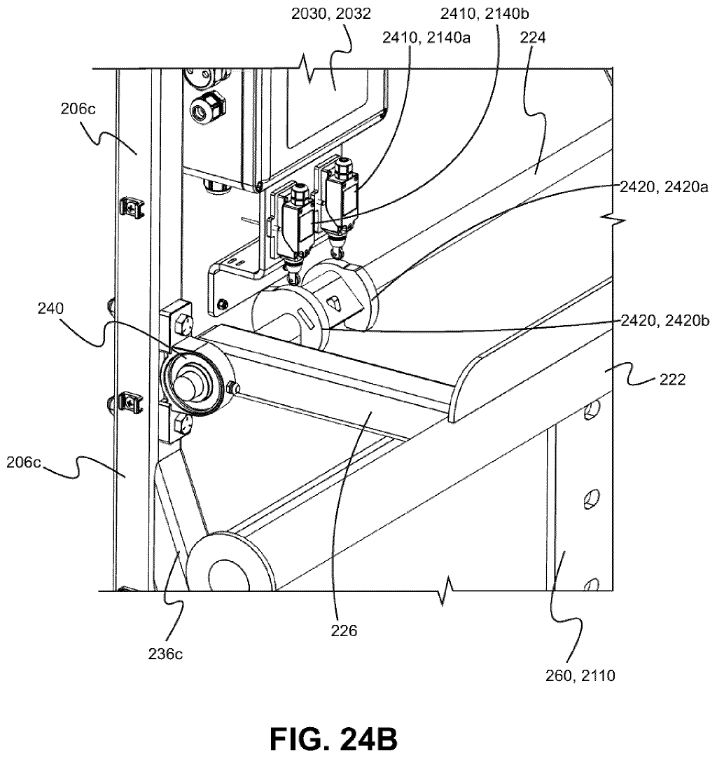

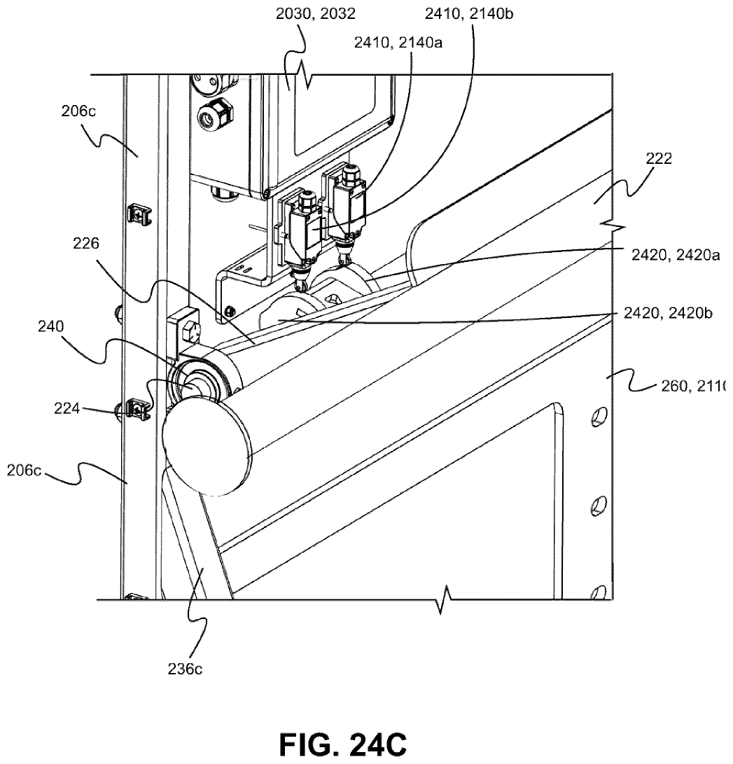

In an additional embodiment, each cam 2420 of the pair of cams 2420 is mounted to the first support structure 220 and is positioned in an offset configuration relative to the other cam 2420 of the pair of cams 2420. The pair of cams 2420 are positioned in this offset configuration, and the offset configuration is defined such that no more than one of the pair of cams 2420 will engage the corresponding limit switch of the pair of limit switches 2410 at any given time. The pair of cams 2420 are positioned on the first support structure 220 such that when the first support structure 220 is in the first position (see FIG. 24A), neither of the pair of cams 2420 engages their corresponding limit switch 2410 of the pair of limit switches 2410. When the first support structure 220 is in the second position (see FIG. 24B), a first cam 2420a of the pair of cams 2420 will engage a first limit switch 2410a of the pair of limit switches 2410 and a second cam 2420b of the pair of cams 2420 remains disengaged from a second limit switch 2410b of the pair of limit switches 2410, and when the first support structure 220 is in the third position (see FIG. 24C), the second cam 2420b engages the second limit switch 2410b and the first cam 2420a is disengaged from the first limit switch 2410a.

In the specific embodiment provided in FIGS. 24A to 24C, the pair of cams 2420 are a pair of circular, disk shaped cams with through-apertures. The pair of cams 2420 are mounted on the support rod 224 of the first support structure 220 and are spaced apart along the length of the support rod 224. The pair of cams 2420 are rotationally offset such that as the support rod 224 pivots about the bearings with the first support structure 220 between the first, second and third rotational positions shown in FIGS. 24A, 24B, and 24C, respectively, the first and second cams 2420a, 2420b of the pair of cams 2420 will rotate with the support rod 224 and selectively engage the pair of limit switches 240 in the manner described above. The limit assembly housing 2430 is mounted to the apparatus frame 206 above the support rod 224 such that engagement ends of the pair of limit switches 2410 extend down through the housing 2430 and are positioned proximate the cylindrical, disk shaped pair of cams 2420.

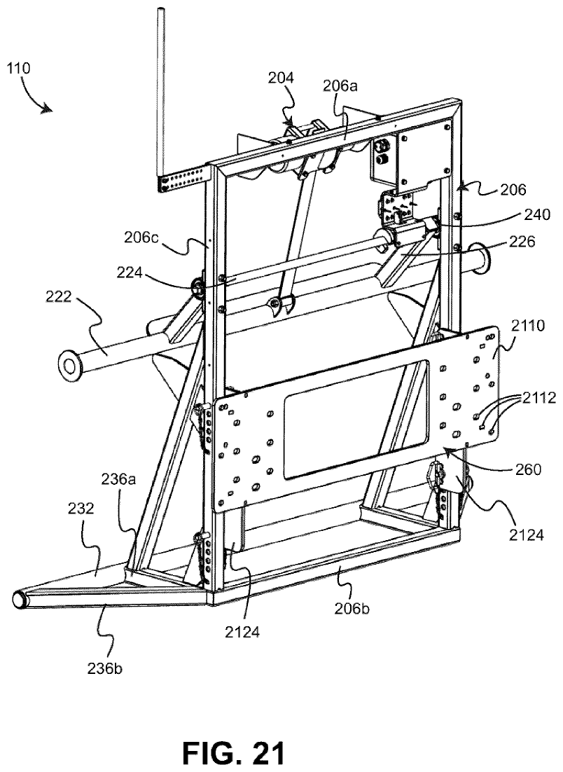

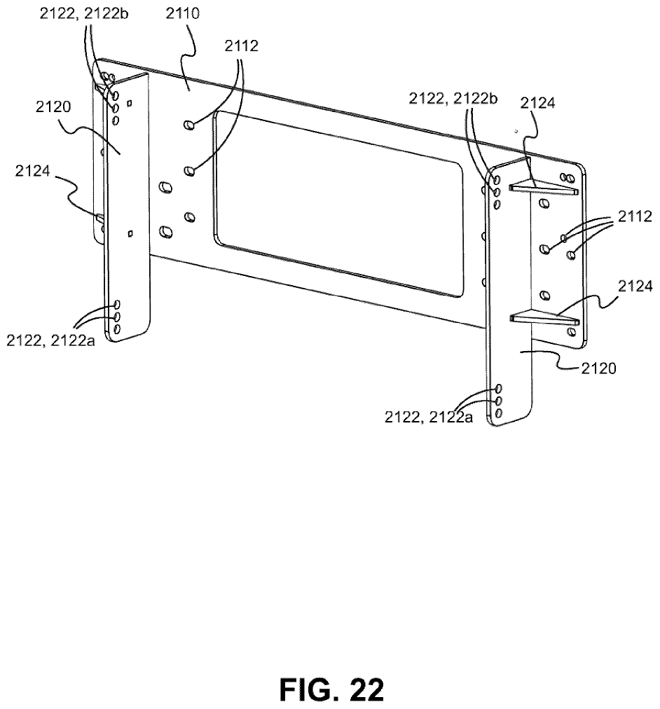

Referring to FIGS. 21 and 22, there is provided an alternate embodiment of the mounting assembly 260 of the apparatus 110 for removably mounting the apparatus 110 to the vehicle 130. As provided above, the apparatus frame 206 is mounted the mounting surface of the vehicle 130 via the mounting assembly 260.

In an embodiment such as shown in FIGS. 21 and 22, the mounting assembly 260 comprises a universal mounting plate 2110, and a pair of vertical mounts 2120 that are each structured to be releasably mounted to one of the pair of vertical members 206c of the apparatus frame 206. The universal mounting plate 2110 is a flat plate with a plurality of mounting holes 2112 formed therethrough. The plurality of mounting holes 2112 can be holes of uniform size and/or sets or pairs of holes of differing sizes. The plurality of mounting holes 2112 are oriented in a pattern about the universal mounting plate 2110 and extend through the mounting plate 2110 so as to facilitate the mounting of the universal mounting plate 2110 to a wide variety of shapes and forms of the vehicle 130, with varying shapes and forms of the mounting surface on the vehicle 130.

In the specific embodiment provided in FIGS. 21 and 22, the universal mounting plate 2110 is a flat, rectangular plate. The universal mounting plate 2110 comprises several sub-groups of the plurality of mounting holes 2112 that are mirrored about a lateral axis of the universal mounting plate 2110 such that each side of the universal mounting plate 2110 has the same pattern of holes. The several sub-groups of the mounting holes 2112 on each side of the universal mounting plate 2110 are disposed on either side of the vertical mounts 200 of the mounting assembly 260.

In an additional embodiment of the mounting assembly 260 as shown in FIGS. 21 and 22, the pair of vertical mounts 2120 comprise a plurality of connecting holes 2122 that comprises a plurality of lower connecting holes 2122a and a plurality of upper connecting holes 2122b. The plurality of upper connecting holes 2122b and plurality of lower connecting holes 2122a correspond to the set of lower connecting apertures 265a and the set of upper connecting apertures 265b of each vertical member 206c of the apparatus frame 206. The plurality of lower connecting holes 2122a and plurality of upper connecting holes 2122b are spaced apart to a substantially similar degree to the set of lower connecting apertures 265a and the set of upper connecting apertures 265b, and are sized such that the securing elements 2020 can be fed through the lower connecting holes 2122a and set of lower connecting apertures 265a, and/or the upper connecting holes 2122b and the set of upper connecting apertures 265b for releasably connecting the mounting assembly 260 to the apparatus frame 206.

In the specific embodiment provided in FIGS. 21 and 22, the pair of vertical mounts 2120 are formed as a pair of rectangular flanges that are mounted perpendicular to the universal mounting plate 2110. The plurality of upper connecting holes 2122b and plurality of lower connecting holes 2122a are formed through the pair of rectangular flanges. A pair of gussets 2124 are secured between each of the pair of vertical mounts 2120 and the universal mounting plate 2110 so as to stabilize each of the pair of vertical mounts 2120 in place.

As with the first embodiment of the apparatus 110, in this alternate embodiment of the apparatus 110, the actuator 204 is connected to the apparatus frame 206 and to the first support structure 220 for driving the actuation of the first support structure 220 from the first position (See FIG. AI) to the second position (See FIG. 21B). The actuator 204 is also connected for driving an actuation of the first support structure 220 from the second position to the third position (i.e., the lifting position) shown in FIG. 21C, such that the apparatus 110 lifts the releasably coupled trailer support 120 relative to the vehicle 130 and off a ground surface on which the trailer support 120 rests.

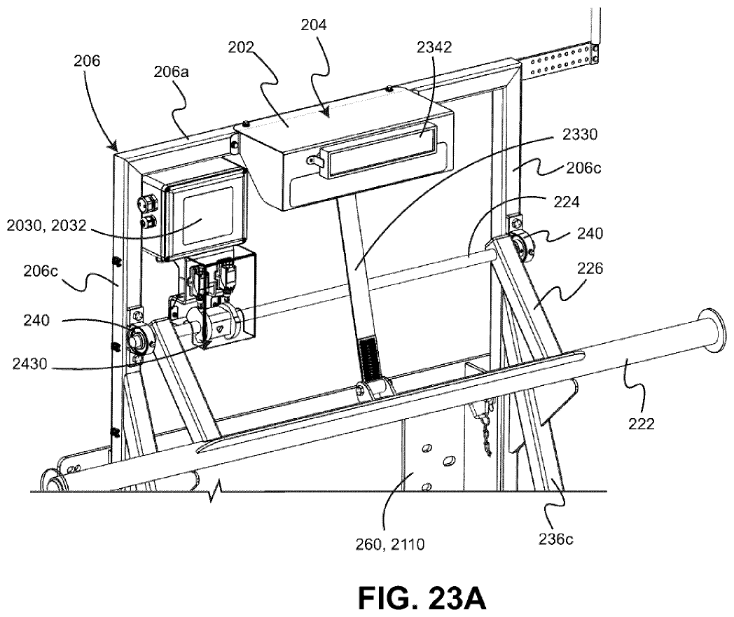

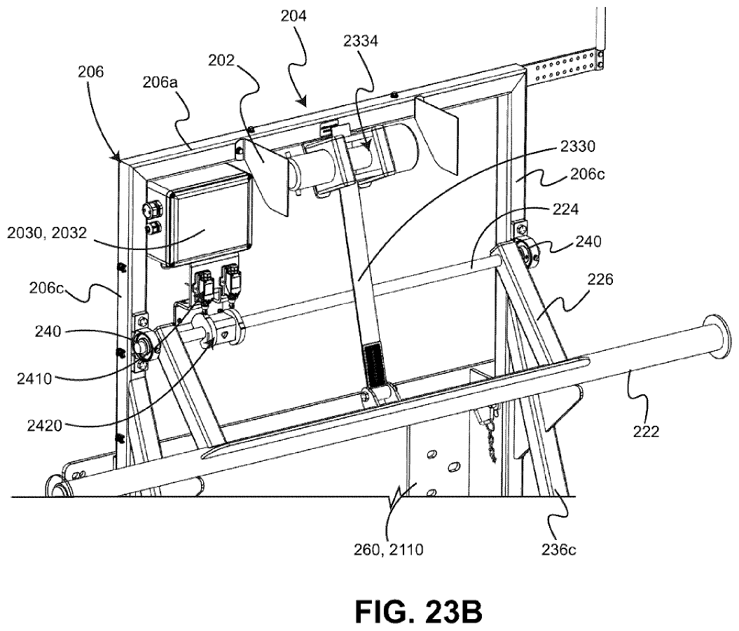

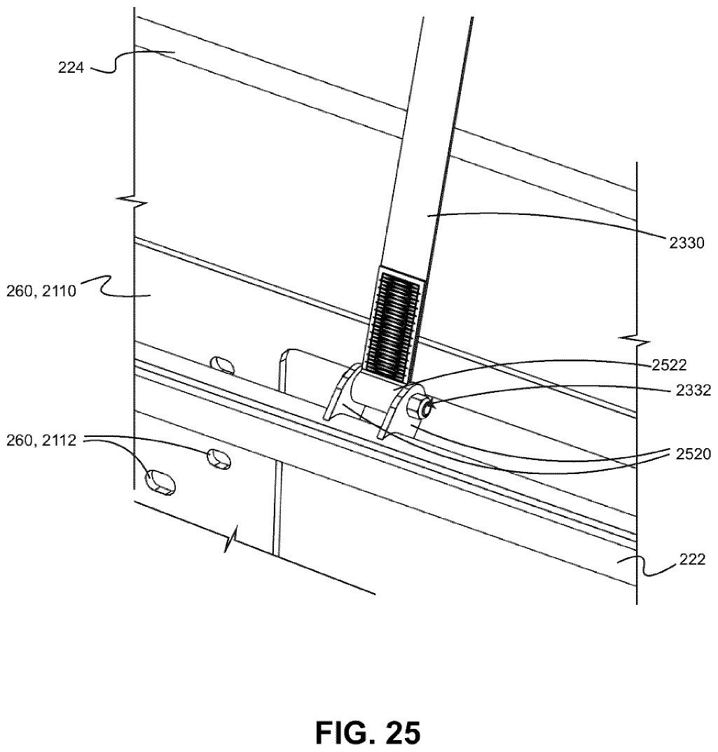

In an embodiment such as provided in FIGS. 23A, 23B and 25, the actuator 204 comprises a nylon strap 2330, a load connector 2332, and a winch 2334, in this embodiment, a nylon strap winch. The load connector 2332 is connected to the first support structure 220 and the winch 2334 is mounted to the apparatus frame 206. A first end of the nylon strap 2330 is connected to the winch 2334 such that as the winch 2334 is driven to rotate in one of two rotational directions, the nylon strap 2330 will be wound or unwound from around a drum assembly of the winch 2334. The other end of the nylon strap 2330 is formed as a loop, where the loop is secured around the load connector 2332.

In an embodiment such as that shown in 23A, 23B and 25, the winch 2334 is the drive portion 204b of the actuator 204, and the winch 2334 comprises a winch drive assembly and a winch drum assembly. Both the drum and drive assembly are mounted within the actuator housing 202.

In the specific embodiments provided in FIGS. 23A, 23B and 25, the actuator 204 is the winch 2334 that is connected to the first circular contact bar (i.e., the first contact member 222) of the first support structure 220, and to the winch drum assembly of the winch 2334. As shown in FIG. 25, the load connector 2330 comprises a pair of flanges 2520 that are mounted to the first contact member 222, where the pair of flanges 2520 can be mounted by various known methods, such as by welding. Each of the pair of flanges 2520 comprises an aperture and a bolt 2522 is mounted through the apertures of the pair of flanges 2520. The loop formed in one end of the nylon strap 2330 is looped around the section of the bolt 2522 that extends between the pair of flanges 2520 such that the looped end of the nylon strap 2330 can pivot about the bolt 2522, In driving the actuation of the first support structure 220 relative to the apparatus frame 206, the winch 2334 will apply tension to the nylon strap 2330, which will in turn pull the first contact member 222 from the first position (shown in FIG. 20A) through to the second position (shown in FIG. 20B), where the beam elements 226 of the first support structure 220 are substantially perpendicular to the vertical members 206c of the apparatus frame 206. From the second position, the winch 2334 can be actuated to release the first contact member 222 back to the first position, or the first contact member 222 can be further driven by the winch to the third position (shown in FIG. 20C) where the first contact member 222 reaches an uppermost point.

In some embodiments of the actuator 204 that comprise the winch 2334 and the nylon strap 2330, the nylon strap 2330 is formed as a sacrificial piece that will yield and break at forces not significant enough to cause damage to other parts of the apparatus 120 (i.e., not sufficient to cause bending or torsion in the members of the first support structure 220 or the apparatus frame 206). In one such embodiment, the first support structure 220 and winch 2334 are structured for removing the trailer support 120 from beneath a trailer by sliding the trailer support 120 out from under the trailer prior to lifting the trailer support 120. Said another way, the apparatus 110 is structured such that, in its preferred mode of operation, the first support structure 220 is actuated from the first position to the second position such that the first support structure 220 is releasably connected to the trailer support 120. Without actuating the first support structure 220 further (i.e., towards the third position), the vehicle 130 is then engaged to drag the trailer support 120 out from underneath the trailer. In the embodiments where the first support structure 220 comprises the winch 2334, the second position of the first support structure 220 where the apparatus 110 is dragging the trailer support 120 backwards is defined by the pair of plurality of beam elements 226 being substantially horizontal, and at approximately ninety-degrees to the vertical members 206c of the apparatus frame 206. In this position, the trailer support 120 is engaged by the apparatus, but a minimum amount of stress is applied to the nylon strap 2330.

In an instance where an operator of the apparatus 110 misjudges the control of the actuator 204 and the first support structure 220 is advanced past the second position towards the third position, while the trailer support 120 is being dragged from underneath the trailer by the apparatus 110, an elevated magnitude of stress will develop in the nylon strap 2330. This elevated magnitude of stress is due to the fact that when the first support structure 220 moves from the second position towards the third positions when connected to the trailer support 120 under the vehicle, the first support structure 220 will apply upwards force on the trailer support 120 (specifically, within the at least one receiving channel 810), but due to the weight of the trailer on the trailer support 120, the first support structure 220 will be unable to lift the trailer support 120 relative to the apparatus frame 206. As the first support structure 220 continues to apply this upwards force on the trailer support 120, the nylon strap 2330 will be stretched and the increase magnitude of stress will be translated to the first support structure 220 and apparatus frame 206 of the apparatus 110.

By providing an embodiment of the nylon strap 2330 where the nylon strap 2330 is sacrificial and will break when it experiences loads above a predetermined magnitude, the elevated forces that are applied on the first support structure 220 and apparatus frame 206 in scenarios such as those described above will not damage the first support structure 220 or apparatus frame 206 of the apparatus 110.

### Control Box and Housing

Referring to FIGS. 23A and 23B, there is provided an embodiment of the apparatus 110, where the apparatus 110 comprises the actuator housing 202 that is mounted to the apparatus frame 206, and the driving portion 204b of the actuator 204 is at least partially contained within the actuator housing 202. In the specific embodiment provided in FIGS. 23A and 23B, the actuator comprises the winch 2334, and winch 2334 is contained within the actuator housing 202. The actuator housing 202 is the box-shaped housing with the open bottom end.

As with the embodiments of the actuator 204 described above, the actuator 204 may be powered by an actuator battery, where the actuator battery is connected to the driving portion 204b of the actuator 204. Alternatively, the actuator 204 may be powered via the battery of the vehicle 130 that is provided on or within the vehicle 130, where the driving portion 204b of the actuator is connected either directly or indirectly to the battery of the vehicle 130 contained on or within the vehicle 130.

In an embodiment such as shown in FIGS. 23A and 23B, the apparatus 110 comprises the control system 2030, where the control system 2030 is housed within a control system housing 2032, and the control system housing 2032 is mounted on the apparatus frame 206. The control system 2030 is contained inside the control system housing 2032, where the control system housing 2032 comprises at least one aperture (not shown) through which electrical connections of the control system 2030 are fed. In an exemplary embodiment, the control system 2030 can comprise connectors such as cables that are connected to the drive assembly of the winch 2334 for controlling the operation thereof, and can also comprise connectors such as cables that are connected to the battery of the vehicle 130 to control the supply of powered to the driving portion 204b of the actuator 204.

In the specific embodiment provided in FIGS. 23A and 23B, the control system housing 2032 is mounted to the apparatus frame 206 adjacent to the actuator housing 202, and is a substantially rectangular, box-shaped housing.

In some embodiments, the connecter that connects the control system 2030 to the battery of the vehicle 130 and/or to the winch 2334 comprises a cable with a quick-disconnect plug attached thereto for facilitating the quick connection and disconnection of the cables connected between the control system 2120, the battery of the vehicle 130 and the winch 2334 (i.e., the driving portion 204b of the actuator 204).

In an additional embodiment such as shown in FIGS. 23A and 23B, the apparatus 110 comprises an illumination element 2340 that is connected to the apparatus frame 206 for illuminating at least a portion of the first support structure 220 of the apparatus 110. The illumination element 2340 may provide this illumination of the first support structure 220 to facilitate easier alignment and connection of the first support structure 220 and the at least one receiving channel 810 of the trailer support 120 by the vehicle 130.

In the specific embodiment provided in FIGS. 23A and 23B, the illumination element 2340 is an LED light bar 2342 that is mounted to a front, vertical face of the actuator housing 202. The LED light bar 2342 is operably connected to the control system 2030 via connector elements such as cables and can be controlled by the driver of the vehicle 130 on which the apparatus 110 is mounted.

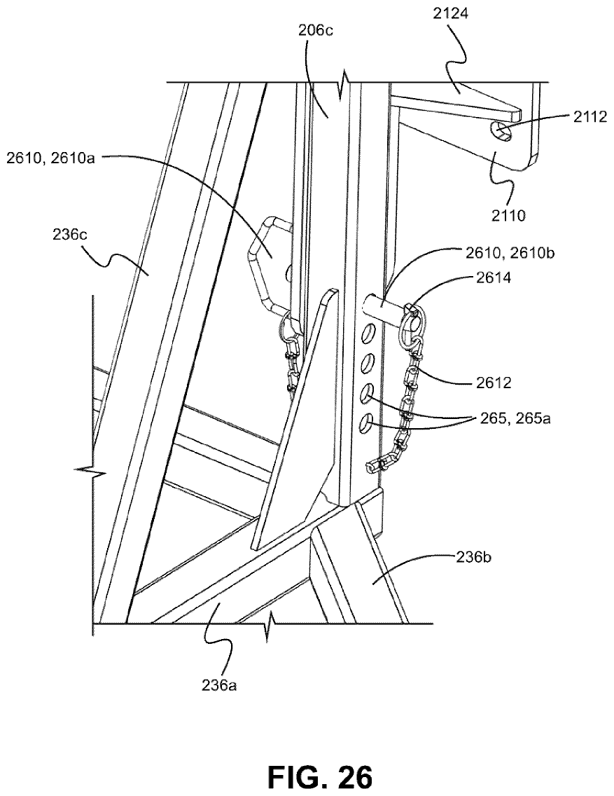

As provided above in reference to FIG. 26, the vertical members 206c of the apparatus frame 206 comprise the set of lower connecting apertures 265a and the set of upper connecting apertures 265b. The pair of vertical mounts 2120 of the mounting assembly 260 comprise the upper connecting holes 2122b and lower connecting holes 2122a that correspond to the set of upper connecting apertures 265b and the set of lower connecting apertures 265a, respectively. Securing elements 2020 are inserted through at least one aperture of the set of upper connecting apertures 265b on each vertical member 206, and through a corresponding hole of the upper connecting holes 2122b of one of the pair of vertical mounts 2120. Securing members 2020 are also inserted through at least one aperture of the set of lower connecting apertures 265a on each vertical member 206, and through a corresponding hole of the lower connecting holes 2122a of the pair of vertical mounts 2120 such that the apparatus frame 206 is secured to the mounting assembly 260.

In the specific embodiment shown in FIG. 26, the apparatus frame 206 is shown connected to the pair of vertical mounts 2120 of the mounting assembly 260. The upper and lower sets 265b, 265a of the plurality of connecting apertures 265 of the apparatus frame 206 are aligned with the upper and lower holes 2122b, 2122a of each of the pair of vertical mounts 2120. In this specific embodiment, each of the securing elements 2020 is formed as a quick release pin 2610. The quick release pin 2610 comprises a pin head 2610a, a pin body 2610b, a chain 2612, and a stopper 2614. The pin body 2610b is inserted through both the connecting aperture 265 of one of the set of upper connecting apertures 265b and the set of lower connecting apertures 265a, and the corresponding hole 2122 of either the upper connecting holes 2122b or lower connecting holes 2122a. The pin body 2610b comprises a through-hole formed on the free end of the body. The chain 2612 comprises one end that is mounted to the pin head 2610a and a second end on which the stopper 2614 is mounted. The chain 2612 is sized such that when the pin body 2610b is inserted through the connecting apertures 265 and holes 2122, the chain 2612 can be looped around the apparatus frame 206 such that the stopper 2614 can be inserted into the through-hole on the end of the pin body 2610b for securing the quick release pin 2610 in place in the connecting apertures 265 and holes 2122 of the apparatus frame 206 and mounting assembly 260.

The plurality of connecting apertures 265 in each of the upper and lower sets 265b, 265a provides for adjustment of the relative position of mounts 261 and the apparatus frame 206. In this way, the mounts 261 can be repositioned relative to the apparatus frame 206 by removing the securing element 2020 or fastener element 267, realigning the through-apertures 266 of the mounts 261 with another pair of connecting apertures 265 of the two sets of connecting apertures 265, and re-inserting the securing element 2020 or fastener element 267.

In this same way, the securing elements 2020 provide for a tilting functionality of the lifting assembly 110 when the lifting assembly 110 is mounted on the front of the vehicle 130, such as on the vehicle bumper.

In the embodiments where the lifting assembly 110 is mounted on the front of the vehicle 130, such as on the vehicle bumper, it may be necessary for a driver or maintenance worker to access regions of the vehicle that can only be accessed by tipping a cab of the vehicle 130 forward (i.e., on a shunt truck that is a tilt-cab shunt truck). To facilitate the tipping of the cab of the vehicle 130 forward, it must also be possible to tilt the apparatus 110 forward relative to the mounting apparatus 260 such that the apparatus 110 does not interfere with the tilting of the cab of the cab of the vehicle 130. In these embodiments, the securing elements 2020 (such as the quick release pins 2610) can be selectively removed from some of the plurality of upper and lower connecting apertures 265b, 265a and the plurality of upper and lower connecting holes 2122b, 2122a to facilitate tilting of the apparatus 110 relative to the mounting apparatus 260.

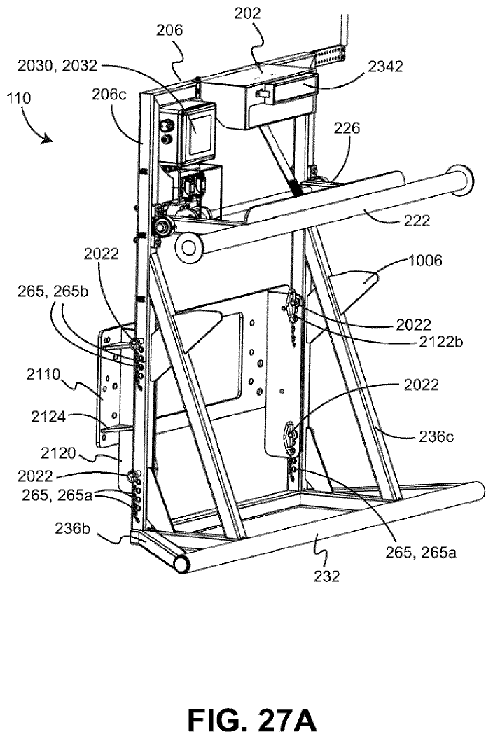

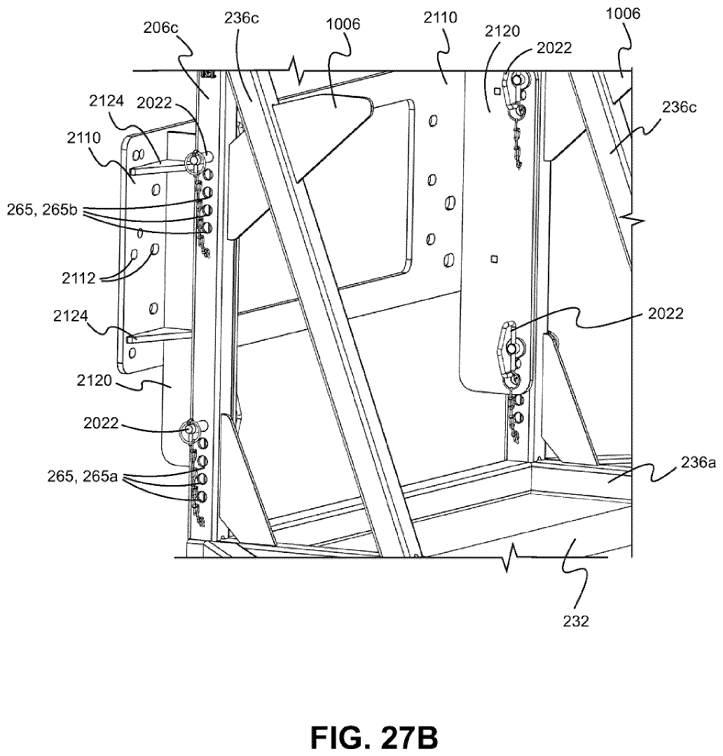

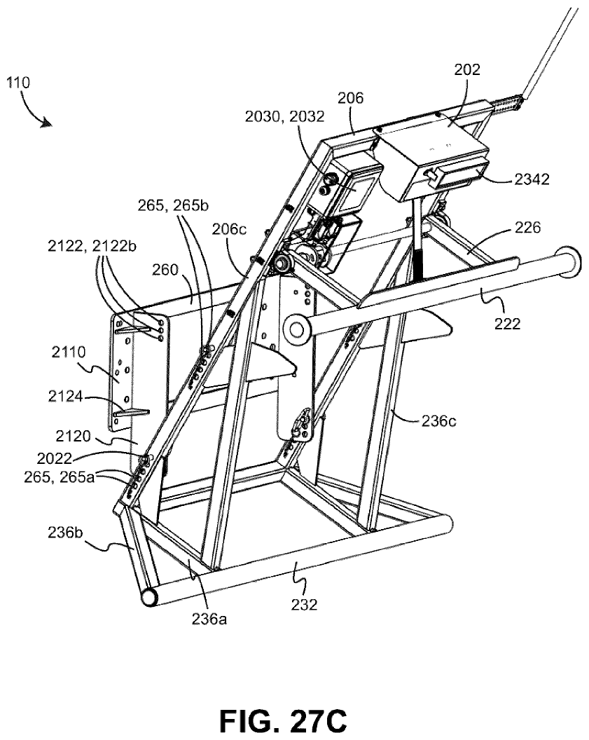

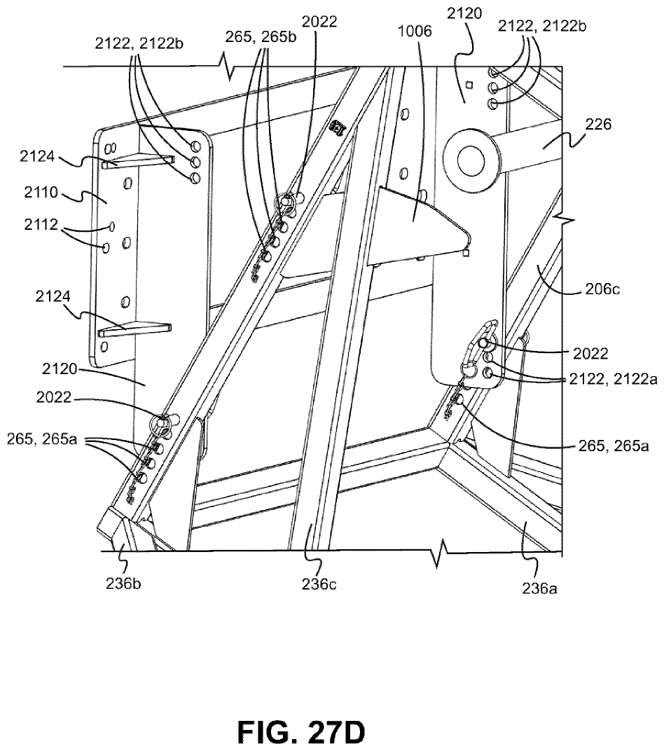

Referring to FIGS. 27A and 27B, the apparatus frame 206 of the apparatus 110 and the mounting assembly 260 are shown secured together via four quick release pins 2610. One of the four quick release pins 2610 is provided through a pair of the upper connecting apertures 265b and the upper connecting holes 2122b on each vertical member 206c, and one of the four quick release pins 2610 is provided through one of the lower connecting apertures 265a and the lower connecting holes 2122a on each vertical member 206c such that the apparatus frame 206 and mounting assembly 260 are connected to each other.

To facilitate the tilting of the apparatus 110 relative to the mounting assembly 260 (and the vehicle 130), the two quick release pins 2610 connected through the upper connecting apertures 265b and the upper connecting holes 2122b on each vertical member 206c are removed, and the apparatus frame 206 is then only connected to the mounting assembly 260 via the quick release pins 2610 still held through the lower connecting apertures 265a and the lower connecting holes 2122a. The apparatus frame 206 of the apparatus 110 can then be tilted forward relative to the mounting assembly 260 and the vehicle 130. As shown in FIGS. 27C and 27D, the apparatus 110 is tipped forward and pivots about an axis defined through the quick release pins 2610 that are still held in the lower connecting apertures 265a and the lower connecting holes 2122a on each vertical member 206c until the apparatus frame 206 is leaning forward at an angle away from the mounting assembly 260 and the vehicle 130.

The above-described embodiments are intended to be examples of the present disclosure and alterations and modifications may be effected thereto, by those of skill in the art, without departing from the scope of the disclosure that is defined solely by the claims appended hereto.

### PART NUMBERS

110 apparatus
120 trailer support
130 vehicle
132 front vehicle bumper
202 actuator housing
204 actuator
204a actuating portion
204b driving portion
206 apparatus frame
206a top member
206b bottom member
206c vertical members
220 first support structure
222 first contact member
224 support rod
226 plurality of beam elements
228 through aperture of angle beam
230 second support structure
232 second contact member
236 plurality of beam elements
236a horizontal beams
236b first angled support beams
236c second angled support beam
240 bearings
252 connecting structure
252a flange
254 load hook
256 load-bearing cable
260 mounting assembly
261 mounts
262 mounting plate
264 vertical bar
265 connecting apertures
265a lower connecting apertures
265b upper connecting apertures
266 through-aperture
267 fastener element securing mount to apparatus frame
282 hard stop bodies
282a upper hard stops
282b lower hard stops
291 alignment body of apparatus
292 alignment body of trailer support
520 gusset
610 length of cable
620 load hook
700 winch
710 winch drive assembly
720 drum assembly
800 shuntable trailer support
800a stepped, shuntable trailer support
810 receiving channel
820 hook-shaped members
832 front legs
833 front cross support
834 rear legs
835 rear cross support
838 bottom plate
842 leg bracing member
844 angled support beams
845 angle brackets
846 support blocks
847 fastener for securing the bottom plate on the support blocks
848 gussets
850 stepped landing assemblies
852 stepped inner plate
854 stepped outer plate
856 frame members
858 bumpers
860 rectangular bar
862 partially elastic plate
864 borehole
880 hooks
882 angled tip portion
890 u-shaped channel
890a concave sidewall portion
891 low friction material
910 securing tab
920 securing hooks
1006 contact plate
1010 end barrier
1010a circular end cap
1020 limiting device
1022 limit switch
1900 repositionable trailer support
1910 secondary receiving channel
1912 keyhole
1920 pair of tubes
1930 reflective element
1940 mounting plate
2010 limiting device assembly
2022 securing element
2030 control system
2032 control system housing
2110 universal mounting plate
2112 mounting holes
2120 pair of vertical mounts
2122 connecting holes
2122a lower connecting holes
2122b upper connecting holes
2124 gussets
2330 nylon strap
2332 load connector
2334 winch
2340 illumination element
2342 LED light bar
2410 limit switches
2410a first limit switch
2410b second limit switch
2420 cams
2420a first cam
2420b second cam
2430 limit assembly housing
2520 pair of flanges
2522 bolt
2610 quick release pin
2610a pin head
2610b pin body
2612 chain
2614 stopper

1-34. (canceled)

35. A portable trailer support comprising:
a support surface engagement element configured to selectively engage a support surface;
a trailer engagement element comprising a stepped assembly comprising a plurality of vertically-oriented steps, each step configured to selectively and independently engage a forward end portion of a trailer;
a positioning element engagement element configured to selectively and releasably couple with a trailer support positioning element of a vehicle; and
a frame carrying the support surface engagement element, the trailer engagement element, and the positioning element engagement element.

36. The portable trailer support of claim 1, wherein the positioning element engagement element comprises at least one receiving element and the trailer support positioning element comprises at least one contact member, wherein the at least one receiving element is configured to selectively and releasably couple with the at least one contact member.

37. The portable trailer support of claim 1, wherein the positioning element engagement element comprises a receiving channel configured to receive the trailer support positioning element.

38. The portable trailer support of claim 37, comprising at least one hook-shaped member defining a channel portion defining the receiving channel.

39. The portable trailer support of claim 37, comprising a plurality of hook-shaped members, each hook-shaped member of the plurality of hook-shaped members, defining a channel portion, wherein collectively, the channel portions of the plurality of hook-shaped members, define the receiving channel.

40. The portable trailer support of claim 1, wherein the trailer support positioning element comprises at least one substantially horizontal contact beam.

41. The portable trailer support of claim 40, wherein the positioning element engagement element comprises at least one hook-shaped member configured to selectively and releasably couple with the at least one substantially horizontal contact beam.

42. The portable trailer support of claim 37, wherein the at least one receiving element comprises a channel configured to receive the trailer support positioning element, the trailer support positioning element comprising at least one substantially horizontal contact beam.

43. The portable trailer support of claim 1, wherein the positioning element engagement element comprises a downwardly facing channel configured to receive the trailer support positioning element, the trailer support positioning element comprising an upwardly facing contact member.

44. The portable trailer support of claim 1, wherein the positioning element engagement element comprises a beam configured to receive the trailer support positioning element, the trailer support positioning element comprising a hook-shaped member.

45. The portable trailer support of claim 1, wherein the trailer support positioning element is positioned at a forward end of the vehicle.

46. The portable trailer support of claim 1, wherein each step comprises a substantially vertical engagement surface or riser arranged to selectively contact the forward vertical wall of the forward end portion of the trailer while the portable trailer support is being positioned beneath the nose of the forward end portion of the trailer.

47. The portable trailer support of claim 1, wherein each step comprises a substantially horizontal engagement surface or tread arranged to be selectively positioned generally horizontally and generally laterally beneath the nose of the forward end portion of the trailer.

48. The portable trailer support of claim 1, wherein the trailer engagement element is configured to at least partially support the forward end portion of the trailer when the support surface engagement element is engaged with the support surface and the trailer engagement element is positioned beneath the nose of the forward end portion of the trailer.

49. The portable trailer support of claim 1, wherein the support surface engagement element comprises a ground pad.

50. The portable trailer support of claim 1, configured for positioning and repositioning relative to the trailer by the vehicle.

51. The portable trailer support of claim 50, configured for positioning and repositioning relative to the trailer by pushing and/or pulling by the vehicle.

52. The portable trailer support of claim 50, configured for positioning and repositioning relative to the trailer by lifting and carrying by the vehicle.

53. An apparatus for manipulating and/or maneuvering a portable trailer support, the apparatus for mounting to a vehicle, the apparatus comprising:
an apparatus frame for mounting the apparatus to the vehicle;
at least one first contact member being movably mounted to the apparatus frame for movement between at least a first position and a second position relative to the apparatus frame, the at least one first contact member configured for being releasably received by the portable trailer support for releasably coupling the trailer support to the apparatus frame when the at least first contact member is moved from the first position to the second position; and
an actuator connected to the apparatus frame and to the at least one first contact member for driving an actuation of the at least one first contact member from the first position to the second position for releasably coupling the portable trailer support to the apparatus frame for manipulating and/or maneuvering the portable trailer support.

54. A combination comprising:
a trailer support positioning element for being movably mounted on a vehicle for movement between at least a first position and a second position relative to the vehicle, the trailer support positioning element configured for being releasably received by a portable trailer support for releasably coupling the portable trailer support to the trailer support positioning element when the trailer support positioning element is moved from the first position to the second position; and
the portable trailer support, wherein the portable trailer support comprises:
a receiving element configured to selectively receive the trailer support positioning element when the trailer support positioning element is in the second position, for releasably coupling the portable trailer support to the trailer support positioning element;
a support surface engagement element configured to selectively engage a support surface; and
a trailer engagement element comprising a stepped assembly comprising a plurality of vertically-oriented steps, each step configured to selectively and independently engage a forward end portion of a trailer.
